(19) United States
(12) Patent Application Publication
(10) Pub. No.: US 2025/0048068 A1
(43) Pub. Date: Feb. 6, 2025

(54) USER PLANE OPTIMIZATIONS USING NETWORK DATA ANALYTICS

(71) Applicant: INTERDIGITAL PATENT HOLDINGS, INC., Wilmington, DE (US)

(72) Inventors: Quang LY, North Wales, PA (US); Michael STARSINIC, Newtown, PA (US); Catalina MLADIN, Hatboro, PA (US); Jiwan NINGLEKHU, Royersford, PA (US); Hongkun LI, Malvern, PA (US); Pascal ADJAKPLE, Great Neck, NY (US)

(21) Appl. No.: 18/925,474

(22) Filed: Oct. 24, 2024

Related U.S. Application Data
(63) Continuation of application No. 18/007,090, filed on Jan. 27, 2023.
(60) Provisional application No. 63/058,570, filed on Jul. 30, 2020.
(60) Provisional application No. 63/147,284, filed on Feb. 9, 2021.

(51) Int. Cl. H04W 4/60; H04L 43/04; H04W 8/20

(52) U.S. Cl. CPC H04W 4/60; H04L 43/04; H04W 8/20

(57) ABSTRACT

A user equipment “UE” may be configured with a client application for data collection, contact information pertaining to a network Application Function “AF,” and data collection information such as parameters, whereby the UE collects data that is specific to the UE and sends it to the AF over a user plane. The data collection parameters may include one or more of a type of data the UE should collect, data associated with one or more analytics IDs and application IDs, a data collection frequency, and a reporting frequency. The data collection information may include a processing requirement, an expiration time for the collected data, a timestamp of the data collection, and/or a correlation identifier that associates the collected data with the UE.

### CROSS-REFERENCE TO RELATED APPLICATIONS

This application claims the benefit of U.S. Provisional Patent Application No. 63/058,570, filed on Jul. 30, 2020, and U.S. Provisional Patent Application No. 63/147,284, filed on Feb. 9, 2021, both titled “User Plane Optimizations Using Network Data Analytics,” the contents of which are hereby incorporated by reference herein.

### BACKGROUND

Machine-To-Machine (M2M), Internet-of-Things (IoT), and Web-of-Things (WoT) network deployments may involve wireless operations such as those described in, for example, 3GPP TS 23.288, Architecture enhancements for 5G System (5GS) to support network data analytics services; V16.3.0 (2020 March); 3GPP SP-190557, Study on Enablers for Network Automation for 5G—phase 2; SP #84 (2019 June); 3GPP TR 23.700-91, Study on enablers for network automation for the 5G System (5GS); Phase 2 (Release 17); V0.4.0 (2020 June); 3GPP TR 23.700-93, Study on Access Traffic Steering, Switch and Splitting support in the 5G system architecture Phase 2 (Release 17); V0.1.1 (2020 June); 3GPP TS 23.501, System Architecture for the 5G System; Stage 2, V16.4.0 (2020 March); 3GPP TS 23.502, Procedures for the 5G System; Stage 2, V16.4.0 (2020 March); 3GPP TS 23.503, Policy and Charging Control Framework for the 5G System; Stage 2, V16.4.0 (2020 March).

### SUMMARY

Traditionally, the focus of network data analytics in cellular systems has been within the network domain. Network operators configure the NWDAF via network policies or through OAM systems to collect data from other network entities and generate analytics that are used to optimize the operations of the cellular network. Thus, UEs are traditionally not involved with data analytics. Despite some work advocating for UEs to provide raw data as inputs for generating analytic, UEs have not been able to request the initiation of data analytics in the network. There are benefits to providing such capability to UEs, especially for optimizing user plane communications.

By allowing communications, whether directly or indirectly, between UEs and UPFs with NWDAF, optimizations to the user plane can be made to improve network performance and simultaneously improve the user experience. In addition, UEs may provide UE specific data to further enhance the analytics that is generated. The disclosed solutions describe methods for enabling the UE request of network data collection and analytics generation and how the NWDAF can perform data collection from UPFs and UEs. Furthermore, mechanisms for the process of user consent of UE data collection are described. The collected UE data may then be used to enhance the analytics generated by the NWDAF.

A UE may request network data collection and analytics support from the NWDAF. The UE may request that data collection about the UE is anonymized. The UE may request data collection and analytics requirements for a PDU session. The UE may provide information that may be used as part of data collection and actions that are performed in response to receiving analytics from the network.

An NWDAF may collect data from the UPF by using existing interfaces. The analytic results may be utilized to optimize user plane communications. The process of UE data collection may occur through the application layer, and data preparation may include the processing of collected UE data.

Mechanisms may be employed for providing, obtaining, checking, validating, and enforcing user consent for data collection operations.

For example, a UE may be configured with a client application for data collection, contact information pertaining to a network Application Function “AF,” and data collection information such as parameters, whereby the UE collects data that is specific to the UE and sends it to the AF over a user plane. The data collection parameters may include one or more of a type of data the UE should collect, data associated with one or more analytics IDs and application IDs, a reporting frequency, and a data collection frequency. The data collection information may include a processing requirement, an expiration time for the collected data, a timestamp of the data collection, and/or a correlation identifier that associates the collected data with the UE.

The data collected may include one or more of a battery level, a battery discharge rate, a battery discharge history, a battery health, a Discontinuous Reception “DRX” configuration, a sleeping state, and a power saving mode, for example. Collected data may also include: an application ID, location information; a Single-Network Slice Selection Assistance Information “S-NSSAI”; a Protocol Data Unit “PDU” session ID; a Downlink “DL” data rate; a number of UL retransmissions; a DL latency; a percentage of device loading; a percentage of access availability; a Quality of Service “QoS” level; and/or a mobility pattern.

The UE may be configured to prepare the collected data by anonymizing, aggregating, and/or normalizing the collected data. The UE may also generate Machine Learning “ML” or Artificial Intelligence “AI” data for use in data analytics, such as AI/ML training set data, AI/ML inference data, and/or AI/ML validation data.

Similarly, a Network Data Analytics Function “NWDAF” may be arranged to receive a request to collect data from a UE, discovering an AF to collect the data, subscribe to the AF to be notified of collection of the data, and receive notifications from the AF regarding the collected data. The NWDAF may receive, via the AF, raw or processed data from the UE. The data may have been processed by the UE and/or the AF, e.g., to be anonymized, aggregated, normalized, and/or processed by a custom function by the UE or AF. The NWDAF may receive ML or AI data, such as AI/ML training, inference, and/or validation data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

A more detailed understanding may be had from the following description, given by way of example in conjunction with the accompanying drawings.

FIG. 1 is a block diagram of an example non-roaming 5G system architecture in reference point representation.

FIG. 2 is a block diagram of an example network data analytics exposure architecture.

FIG. 3 is a block diagram of an example of non-roaming and roaming with local breakout architecture for ATSSS support.

FIG. 4 is a call flow diagram of an example of PDU session establishment by UE request for data analytics.

FIG. 5 is a call flow diagram of an example of PDU session modification triggered by UE and NWDAF (with data analytics).

FIG. 6 is a call flow diagram of an example of a MA PDU session modification triggered by UE.

FIG. 7 is a call flow diagram of an example of a UPF data collection subscription through SMF.

FIG. 8 is a call flow diagram of an example where an SMF anonymizes data collection sent to an NWDAF.

FIG. 9 is a call flow diagram of an example where a UE provides data for a data collection report.

FIG. 10 is a call flow diagram of an example of the UE data collection process through the application layer.

FIG. 11 is a call flow diagram of an example of the transmission of Data Preparation policy to the AF.

FIG. 12 illustrates an example of the user consent profile

FIG. 13 is a call flow diagram of an example of the user consent configuration and validation process.

FIG. 14 is a call flow diagram of an example of an AF establishing user consent context.

FIG. 15 illustrates an example graphical user interface for requesting data analytics within an application.

FIG. 16A illustrates an example communications system in which the methods and apparatuses described and claimed herein may be embodied.

FIG. 16B is a block diagram of an example apparatus or device configured for wireless communications.

FIG. 16C is a system diagram of an example radio access network (RAN) and core network.

FIG. 16D is a system diagram of another example RAN and core network.

FIG. 16E is a system diagram of another example RAN and core network.

FIG. 16F is a block diagram of an example computing system.

FIG. 16G is a block diagram of another example communications system.

### DETAILED DESCRIPTION

TABLE 0
Abbreviations

| | |
|---|---|
| 3GPP | Third Generation Partnership Project |
| 5G-GUTI | 5G Globally Unique Temporary Identifier |
| 5GS | 5G System |
| AF | Application Function |
| AI | Artificial Intelligence |
| AMF | Access and Mobility Management Function |
| ATSSS | Access Traffic Steering, Switching, Splitting |
| BP | Branching Point |
| CN | Core Network |
| DL | Downlink |
| DRX | Discontinuous Reception |
| FAR | Forwarding Action Rule |
| GPSI | General Public Subscription Identifier |
| GUI | Graphical User Interface |
| IP | Internet Protocol |
| MAR | Multi-Access Rule |
| MDT | Minimization of Drive Tests |
| ML | Machine Learning |
| MNO | Mobile Network Operator |
| MoS | Mean Opinion Score |
| NAS | Non-Access Stratum |
| NEF | Network Exposure Function |
| NF | Network Function |
| NWDAF | Network Data Analytics Function |
| OAM | Operation Administration and Maintenance |
| PCF | Policy Control Function |
| PDU | Protocol Data Unit |
| PLMN | Public Land Mobile Network |
| PMF | Performance Measurement Function |
| QoS | Quality of Service |
| RAN | Radio Access Network |
| RRC | Radio Resource Control |
| RTT | Round Trip Time |
| S-NSSAI | Single - Network Slice Selection Assistance Information |
| SID | Study Item Description |
| SMF | Session Management Function |
| SUPI | Subscription Permanent Identifier |
| UDM | Unified Data Management |
| UDR | Unified Data Repository |
| UE | User Equipment |
| UL | Uplink |
| UL-CL | Uplink Classifier |
| UP | User Plane |
| UPF | User Plane Function |
| URSP | User Route Selection Policy |
| V2X | Vehicle-to-Everything |

### 5G System Architecture

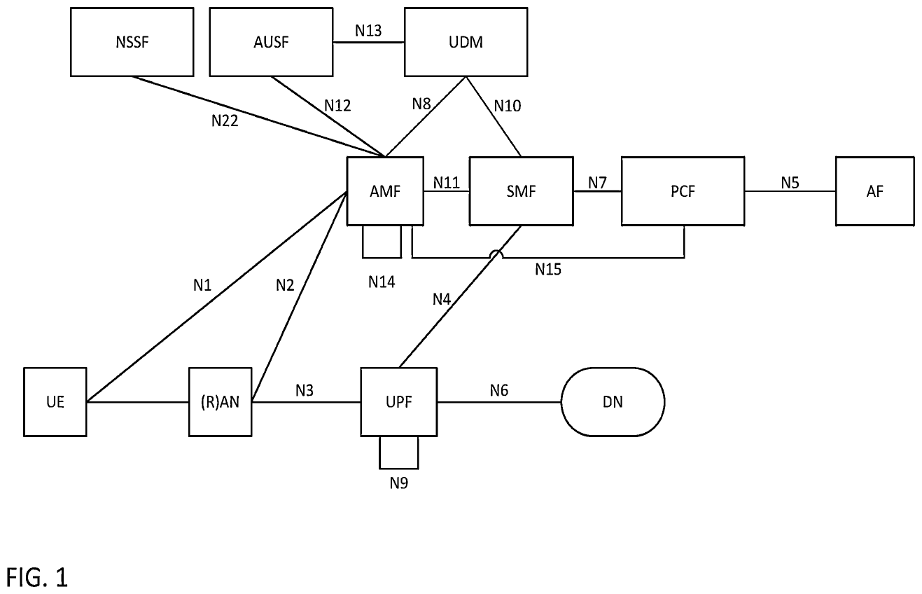

FIG. 1 shows the 3GPP 5G non-roaming system architecture where various entities interact with each other over the indicated reference points. A User Equipment (UE) may communicate with a Core Network (CN) to establish control signaling and enable the UE to use services from the CN. Examples of control signaling functions are registration, connection and mobility management, authentication and authorization, session management, etc. See GPP TS 23.501, System Architecture for the 5G System; Stage 2, V16.4.0 (2020 March).

The following are six of the Network Functions (NFs) from FIG. 1 that are involved with control signalling.

Access and Mobility Function (AMF): The UE sends an N1 message through the RAN node to the AMF to perform many control plane signaling such as registration, connection management, mobility management, access authentication and authorization, etc.

Session Management Function (SMF): The SMF is responsible for session management involved with establishing PDU sessions to allow UEs to send data to Data Networks (DNs) such as the internet or to an application server and other session management related functions.

Policy and Control Function (PCF): The PCF provides the policy framework that governs network behavior, accesses subscription information to make policy decisions, etc.

Authentication Server Function (AUSF): The AUSF supports authentication of UEs for 3GPP and untrusted non-3GPP accesses.

Unified Data Management/Repository (UDM/UDR): The UDM/UDR supports generation of 3GPP AKA Authentication Credentials, user identification handling, subscription management and storage, etc.

Network Slice Selection Function (NSSF): The NSSF is involved with aspects of network slice management such as selection of network slice instances for UEs, management of NSSAIs, etc.

The RAN node offers communication access from the UE to the core network for both control plane and user plane communications. A UE establishes a PDU session with the CN to send data traffic over the user plane through the (R)AN and UPF nodes of the 5G system (5GS). Uplink traffic is sent by the UE and downlink traffic is received by the UE using the established PDU session. Data traffic flows between the UE and the DN through the intermediary nodes: (R)AN and UPF.

### Network Data Analytics Function (NWDAF)

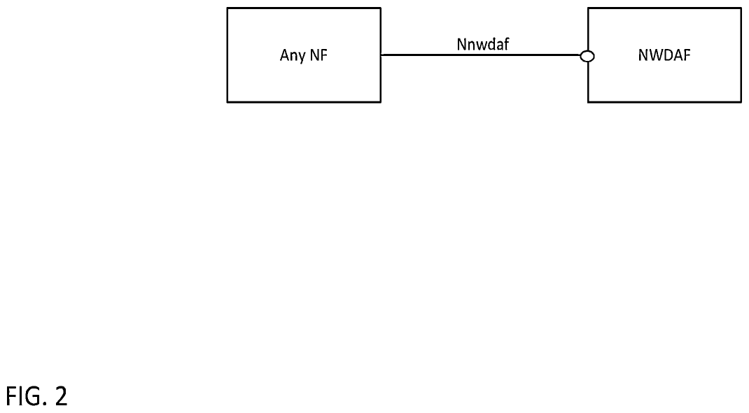

Another network node that exists in the 5GS but not shown in FIG. 1 is the Network Data Analytics Function (NWDAF). The NWDAF in the 5G system provides data analytics to service consumers in the system. The NWDAF may generate either statistic or predictive outputs to aid in network status monitoring and performance improvements. FIG. 2 shows the network data analytics exposure architecture where any network functions or OAM entity in the 5G system can request analytics from the NWDAF. This exposure architecture is defined in more detail in Section 6.1 of 3GPP TS 23.288, Architecture enhancements for 5G System (5GS) to support network data analytics services; V16.3.0 (2020 March). For the NWDAF to generate analytic outputs, data must first be collected from other network functions or OAM entities in the 5G system. The NWDAF may subscribe to collect data from NFs such as AMF, SMF, PCF, etc.; from OAM entities; and from Application Functions (AFs) through the Network Exposure Function (NEF). Section 6.2 of TS 23.288 describes the procedures for data collection by the NWDAF. After receiving the data, the NWDAF will process the data, generate statistic or predictive outputs, and send the output to the NF or OAM entity that requested the analytics.

When requesting analytics from the NWDAF, NFs or OAM entities specify the desired type of analytics using an Analytics ID, e.g., such as those defined in TS 23.288. The Analytics IDs define the type of output that is generated, the target entities the analytics is performed on, the data that is required for the analytics, the source from where the data is received from, the target period of the analytics, and other parameters as defined in TS 23.288. The following list of nine Analytics IDs were copied from TS 23.288 to show the currently defined Analytics IDs.

Load level information: The NWDAF provides slice load level information to an NF on a Network Slice instance level.

Service Experience: This clause specifies how NWDAF can provide Observed Service Experience (e.g., an average observed Mean Opinion Score (MoS) of Service) analytics, in the form of statistics or predictions, to a service consumer. The Observed Service Experience analytics may provide one or both of the following: service experience for a network slice or service experience for an application.

NF load information: The clause 6.5 describes how NWDAF can provide NF load analytics, in the form of statistics or predictions or both, to another NF.

Network Performance: With Network Performance Analytics, NWDAF provides either statistics or predictions on the load, communication and mobility performance in an Area of Interest; in addition, NWDAF it may provide statistics or predictions on the number of UEs that are located in that Area of Interest.

UE mobility: NWDAF supporting UE mobility statistics or predictions shall be able to collect UE mobility related information from NF, OAM, and to perform data analytics to provide UE mobility statistics or predictions.

UE communication: In order to support some optimized operations, e.g., customized mobility management, traffic routing handling, or QoS improvement, in 5GS, an NWDAF may perform data analytics on UE communication pattern and user plane traffic, and provide the analytics results (e.g., UE communication statistics or prediction) to NFs in the 5GC.

Abnormal behaviour: This clause defines how to identify a group of UEs or a specific UE with abnormal behaviour, e.g., being misused or hijacked, with the help of NWDAF.

User Data Congestion: User Data Congestion related analytics can relate to congestion experienced while transferring user data over the control plane or user plane or both. A request for user data congestion analytics relates to a specific area or to a specific user.

QoS Sustainability: The consumer of QoS Sustainability analytics may request the NWDAF analytics information regarding the QoS change statistics for an Analytics target period in the past in a certain area or the likelihood of a QoS change for an Analytics target period in the future in a certain area.

There is ongoing work in the 3GPP FS eNA Ph2 study to investigate further enhancements to the NWDAF. See 3GPP SP-190557, Study on Enablers for Network Automation for 5G—phase 2; SP #84 (2019 June). The study has identified a number of key issues that are captured in 3GPP TR 23.700-91, Study on enablers for network automation for the 5G System (5GS); Phase 2 (Release 17); V0.4.0 (2020 June). Three of the key issues pertinent to user plane optimizations and real-time analytics are copied from TR 23.700-91 and listed below for convenience.

KI #10 NWDAF Assisted UP Optimization: NWDAF implementations, as per Release 16 standards, can provide network performance analytics. This also includes communication and mobility information and the amount of UEs located in an area of interest. While network performance provided by NWDAF can already be a useful source of information for analytics consumer decisions, it is necessary to investigate how to further enhance NWDAF network performance functionality to enable visibility of key users to support user-aware performance optimization through data path management. No user or user group customization is possible when users are only counted. However, the ability to discern between different user types gives greater flexibility and accuracy to optimization activities. In particular, NWDAF should provide analytics that points to the users that are driving network activity in a particular area of interest

KI #18 Enhancement for real-time communication with NWDAF: The validity of an analytics output at a consumer NF is also affected by the timely delivery of the output by the NWDAF, e.g., when the network status changes rapidly and drastically. In this case, an output should be timely provided to a consumer NF by the NWDAF to allow the consumer NF to use the analytics output for proper reaction/decision.

KI #21 NWDAF assisting in user plane performance: One area where NWDAF could help is in providing user plane performance analytics, e.g., in relation with the UL/DL throughput, the packet loss rate, the RTT, etc. possibly per Application Id.

Another aspect that may impact UP optimization concerns with the collection of UE data that may be used in generating analytics. The FS_eNA_Ph2 study also addresses this concern as described by the two key issues listed below, also copied from TR 23.700-91 and listed below for convenience.

KI #8 UE data as an input for analytics generation: This key issue addresses whether and how to enhance the 5GS to support collection and utilization of data provided by the UE in NWDAF in order to provide input information to generate analytics information (to be consumed by other NFs).

KI #15 User consent for UE data collection/analysis: In Rel-16, standard has already specified operator can collect network data or AF data and do analytics based on it. However, user's consent of per UE data retrieving and user's consent of per UE data analysis are not discussed.

### Access Traffic Steering, Switching, Splitting (ATSSS)

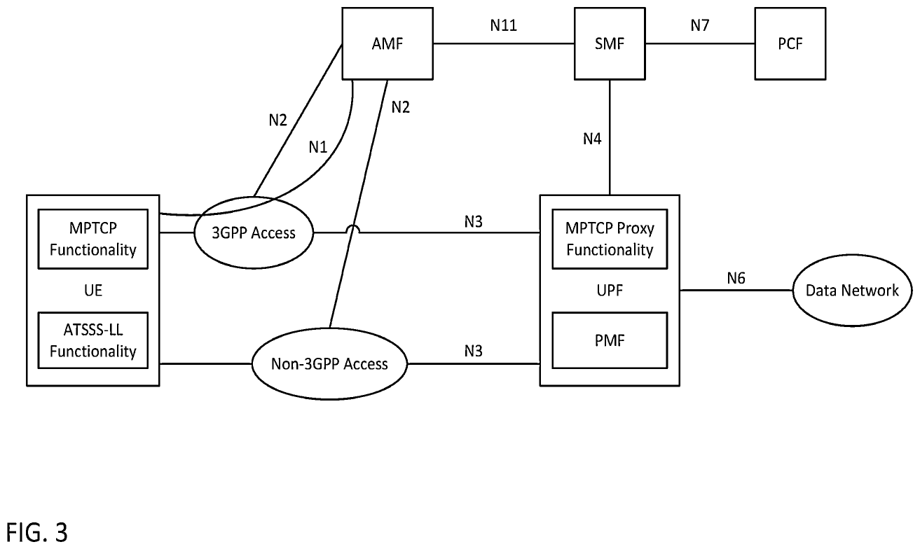

The Access Traffic Steering, Switching, and Splitting (ATSSS) feature introduced in Release 16 allows a UE and a UPF to route traffic over either 3GPP access, non-3GPP access, or over both accesses. A UE creates a Multi-Access (MA) PDU session to enable this feature and the SMF generates ATSSS and N4 rules for the UE and UPF respectively. The rules are used by the UE and UPF to route UL and DL traffic over the two available accesses: 3GPP and non-3GPP access. FIG. 3 shows an example 5G architecture supporting the Access Traffic Steering, Switching, Splitting (ATSSS) feature in Release 16.

A steering mode is specified in ATSSS and N4 rules to inform the UE and the UPF, respectively, on how to distribute UL and DL traffic over 3GPP and non-3GPP accesses. FIG. 3 illustrates an example of non-roaming and roaming with local breakout architecture for ATSSS support. The following four steering modes are currently defined in 3GPP TS 23.501, System Architecture for the 5G System; Stage 2, V16.4.0 (2020 March).

Active-Standby: It is used to steer an SDF on one access (the Active access), when this access is available, and to switch the SDF to the available other access (the Standby access), when Active access becomes unavailable. When the Active access becomes available again, the SDF is switched back to this access. If the Standby access is not defined, then the SDF is only allowed on the Active access and cannot be transferred on another access.

Smallest Delay: It is used to steer an SDF to the access that is determined to have the smallest Round-Trip Time (RTT). As defined in clause 5.32.5, measurements may be obtained by the UE and UPF to determine the RTT over 3GPP access and over non-3GPP access. In addition, if one access becomes unavailable, all SDF traffic is switched to the other available access, if allowed by the PCC rules (as specified in clause 5.32.4).

Load-Balancing: It is used to split an SDF across both accesses if both accesses are available. It contains the percentage of the SDF traffic that should be sent over 3GPP access and over non-3GPP access. Load-Balancing is only applicable to non-GBR QoS flow. In addition, if one access becomes unavailable, all SDF traffic is switched to the other available access, as if the percentage of the SDF traffic transported via the available access was 100%.

Priority-based: It is used to steer all the traffic of an SDF to the high priority access, until this access is determined to be congested. In this case, the traffic of the SDF is sent also to the low priority access, e.g., the SDF traffic is split over the two accesses. In addition, when the high priority access becomes unavailable, all SDF traffic is switched to the low priority access. How UE and UPF determine when a congestion occurs on an access is implementation dependent.

In Release 17, work continues to enhance the ATSSS feature that was introduced in Release 16. One of the proposed solution in 3GPP TR 23.700-93, Study on Access Traffic Steering, Switch and Splitting support in the 5G system architecture Phase 2 (Release 17); V0.1.1 (2020 June) introduces a new steering mode: Autonomous steering mode with advanced PMF. This proposed solution provides both the UE and the UPF the flexibility to dynamically adjust the traffic splitting percentages between 3GPP and non-3GPP accesses based on advanced link measurements that are proposed in the solution. New measurements such as packet loss ratio and jitter measurements are added to the Availability Report and Round-Trip Time (RTT) measurements already defined in Release 16. Furthermore, these measurements are proposed to be performed on a per QoS Flow basis using the PMF protocol to accurately reflect the link status of the traffic.

### Example Challenges

Consider the case of a local city government that is working on an initiative to increase tourism revenue by introducing an interactive app that tourists can use to explore the city. The online app is based on a scavenger hunt concept where main attractions of the city are featured in the app. Tourists download the app on their phones and solve riddles and clues to locate items placed in different neighborhoods throughout the city. The app highlights the history of the city and provides descriptions of the various attractions and neighborhoods that tourists may find interesting. A component of the app includes a multiplayer game that requires players to capture a selfie of themselves at the location of the discovered items as proof to progress further in the game.

As players navigate through the different neighborhoods, their phone may connect to either the cellular network or WiFi networks. The cellular networks and WiFi networks provide access to various edge servers that allow the user to remain connected to the central game server(s). Some of the attractions may feature an augmented reality component to enable a more immersive experience at an attraction and thus require connection to a local edge server for low latency communications. Due to the anticipated number of players, the NWDAF in the network may be used to perform analytics of user traffic in order to optimize user plane communications while preserving a certain quality of service. The optimizations may assist in determining the best access networks for communications, determining the available edge computing servers to handle the traffic, updating policy information in the PCF to assist the SMF in deciding on the allowance of future PDU sessions, etc.

Another aspect of the use case is the collection of UE data that may be utilized to analyze UE conditions to further optimize user plane communications. In addition, user consent may need to be provided in order for the network to collect the data from UEs used for analytics.

This presents some challenges. Currently in the 3GPP architecture, the NWDAF collects data from and provides analytic service to many network entities in the 5G system. However, the NWDAF cannot collect data from the UPF and it cannot provide analytic outputs to the UPF. Since the UPF is actively involved in routing data traffic over the user plane, the UPF can be enhanced to provide data to the NWDAF that corresponds to the service experience of users and network performance metrics collected from the user plane. In turn, the NWDAF may be enhanced to perform analytics on the data provided by the UPF and generate statistics and/or predictions that could be used to improve network performance in the system. Therefore, optimizations can be made in the user plane to maintain or improve the user experience. For example, analytics may be used to load balance traffic among different UPFs, to dynamically split traffic between access networks, to assist in selecting and allocating edge computing resources for latency sensitive applications, etc.

Similarly, the UE is not able to request data collection and analytic services from the NWDAF, whether directly or indirectly through another network function. The UE is the recipient of the services provided by the 5G system and is in the best position to provide data and feedback of the user experience to the NWDAF. Architecturally, it may not be feasible to incorporate direct communications between the UE and the NWDAF. However, it may be feasible to enhance existing procedures to allow UEs to request data collection and analytic services from the NWDAF through other network functions. Furthermore, UE specific data may also be provided to further enhance data analytics and the resulting analytics generated by the NWDAF may then be utilized to optimize user plane communications. For UE data collection to commence, user consent may be required.

The solutions disclosed herein involve enabling a UE to communicate to the CN the need for collecting data and generating analytics on behalf of the UE to optimize user plane communications. The UE may provide one or more indications during PDU session establishment and modification procedures to communicate this need to the CN without introducing a direct interface between the UE and the NWDAF. Upon receiving an indication requesting network data collection and analytics generation for the UE, the SMF coordinates between the UPF and the NWDAF to establish data collection and analytics generation on behalf of the UE. The SMF may use other indications provided by the UE to anonymize the data collected and request real-time data collection to ensure timely data analytics generation while also preserving UE privacy. The SMF may further use other information provided by the UE as part of data collection for the NWDAF and to determine what actions to perform in response to receiving analytics from the NWDAF

As part of requesting data analytics, a UE may also provide UE specific data for the NWDAF to use in generating the analytics. Several methods are disclosed in which the UE may provide data for analytics over the user plane: over IP, NAS, or RRC protocols. Data may be sent by enhancing NAS and RRC protocols so the UE data may be routed to the NWDAF. When sending data over the IP protocol, a UE can send data to either a UPF or an application server/AF, which then forwards the UE data to the NWDAF. When sending data to a UPF, the UPF may be configured to forward UE data to the NWDAF through the SMF. When sending UE data to an application server/AF, a client app may be installed in the UE to provide the UE specific data to the AF, which then forwards the data to the NWDAF through the NEF.

In order for the network to collect data from the UE, the network must first obtain user consent. First, user consent is obtained from the user and stored in the network with the UE's subscription information. Then the user consent needs to be disseminated to all data collectors in the network and enforced per the user consent. Care must be taken by data collectors to ensure user privacy and associated requirements are maintained throughout the duration of the user consent. At the expiration of the user consent, data collectors need to ensure proper handling of the collected data, including the removal of the data.

There are many benefits for UEs to request data collection and analytics from the NWDAF to optimize UP communications. A UE is in the best position to know when to request data analytics as service degradation directly impacts the UE. The UE may provide UE specific data to the NWDAF using one of several methods to assist the NWDAF to generate better analytics and the resulting analytics may be used by the SMF in UPF reselection for when UEs are experiencing delayed packets from an overloaded UPF and over time, the traffic analysis may inform the network about the traffic patterns of the user plane, which may help the network make decisions on the “quality of service” that the traffic can be treated with. The analytics may also be used to make ATSSS steering and splitting decisions more dynamic—the analytics may even predict service degradation and proactively steer traffic to another UPF or access network. Furthermore, the analytics may drive decisions in the SMF to select local edge servers, steer traffic between LTE or 5G networks, insert UL-CL or BP UPFs, or even update policies about PDU session allowance, etc.

### UE Initiated Data Analytics—PDU Session Establishment

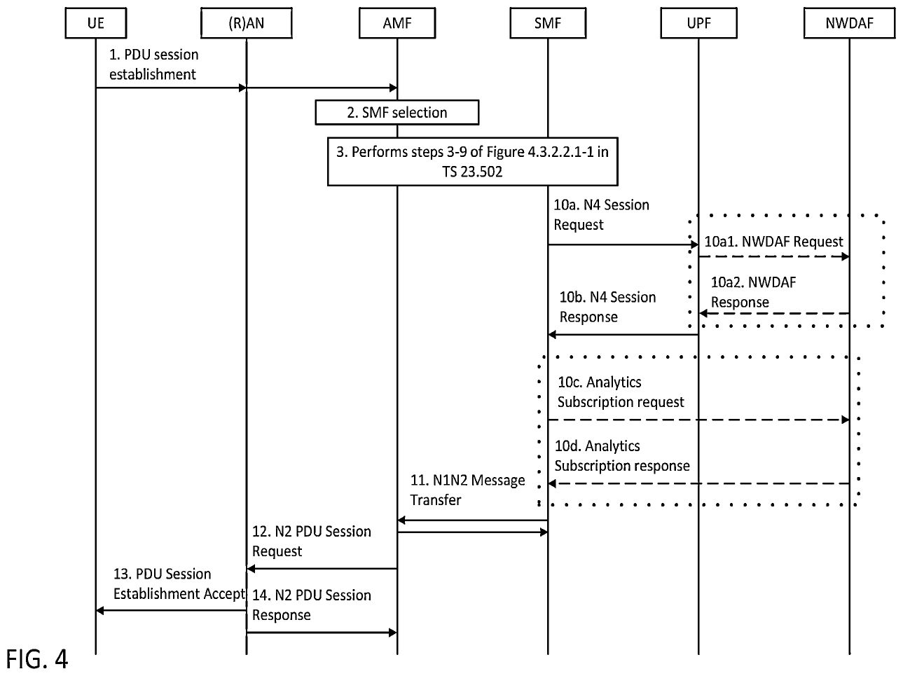

For certain use cases, a user may trigger via a graphical user interface (GUI) on a UE to request network data collection and analytics to optimize UP communications when requesting services for a PDU session. The GUI may be part of a prompt shown at the launch of an application on the UE and the user may want to minimize interruptions for a virtual gaming session, an AR or VR experience, or for a V2X application during a work commute or road trip. Thus, UEs may trigger data collection and analytics generation from the NWDAF during PDU session establishment procedure by including an indication that may be used to request data collection and analytics from the NWDAF. The indication may be used to select appropriate Analytic IDs, or a list of Analytic IDs may be specified by the UE in addition to providing the indication. The UE may include other information when requesting network data collection and analytics: request to ensure privacy of data collection, data collection and analytics requirements for the PDU session, list of network slices it is allowed to use, list of recent locations, request for local edge servers, input to UE mobility analytics for example intended travel routes, input to UE communication analytics such as list of services or applications the UE intends to use during a predefined time period in the future, list of S-NSSAI the UE intends to use, list of target DNNs the UE intends to use, expected service experience requirement for the PDU session for example target opinion score or observed opinion score per service flow/IP filter during a certain time period, target QoS range, observed QoS attributes, target or observed QoS flow retainability, etc. FIG. 4 shows the PDU Session Establishment procedure from TS 23.502 annotated with new steps the SMF performs to enable UE initiated data collection and analytics from the NWDAF.

Steps 1-9 of FIG. 4: The UE sends a PDU Session Establishment request in step 1 to the CN. In the request, the UE includes an indication specifying the type of analytic treatment requested for this PDU session. The indication indicates to the network that the UE is capable and willing to provide data for analytics to the network and for the network to perform analytics to optimize the UP communication for this PDU session. For example, the user of a UE may have used a GUI to locally configure the UE to provide certain measurements to the network that may be used for generating analytics. The capability indication may be a single bit indication, or it may be multiple indications. For example, multiple indications may be used to indicate to the network that the UE can provide certain types of data for certain types of analytics, that the UE can provide certain classes of data for analytics, etc. Other indications may be used to request anonymized data collection and analytics as well as place requirements for data collection and analytics generation for the PDU session. The UE may also provide other information as previously disclosed, such as a list of services or applications the UE intends to use, expected service experience requirement for the PDU session, target QoS range, etc. The SMF uses the indications and the other information to communicate to the NWDAF that data collection and/or analytics is desired to optimize UP communications for the UE. The network (e.g., SMF) may obtain subscription information from the UDM/UDR that indicates whether the subscriber is willing to share certain types of data for analytics. The SMF may store internally other information that was provided by the UE in step 1, such as the list of services or applications the UE intends to use, expected service experience requirement for the PDU session, target QoS range, etc. Some information may be used by the SMF to determine future actions to be performed in response to analytic results received from the NWDAF while other information may be used by the SMF to generate data for collection by the NWDAF. The actions taken may involve properly selecting the appropriate edge computing server(s), enabling dynamic ATSSS steering modes and providing adjustable steering percentages, perform UPF reselection, add UL CL/BP UPFs to UP path, etc. The request is processed as described in FIG. 4.3.2.2.1-1 of TS 23.502 for steps 2 to 9 but with the inclusion of the new indications.

Steps 10a-b: The SMF sends an N4 Session Establishment request to the UPF as part of the normal PDU Session Establishment procedure. The SMF may include the analytics indications and other information such as one or more Analytics IDs, a UE identifier or some token identifier associated with the UE, the periods when data collection are required and when analytics are valid for, information specifying data collection requirements, etc. With the information provided by the SMF, the UPF performs in step 10al either an Nnwdaf AnalyticSubscription_Subscribe or an Nnwdaf AnalyticsInfo_Request service operation to obtain analytics for the UE and the NWDAF responds in step 10a2. The analytics generated by the NWDAF can then be used to optimize UP communications.

Steps 10c-d: As an alternative to steps 10al and 10a2, the SMF may contact the NWDAF directly and subscribe to receive analytics for the UE. In this alternative, the SMF will manage the analytics subscription to NWDAF as well as the data collection required for the analytics. Therefore, the NWDAF will collect data from the UPF through the SMF. Steps 10al and 10a2 require the UPF to have a service based interface and be able to communicate with the NWDAF. Presently in 3GPP specifications, this interface and communications between the UPF and NWDAF do not exist. Absent the interface, the alternative is for the NWDAF to collect data from the UPF through the SMF. The UPF already reports data about the PDU session to the SMF over the N4 interface between the UPF and the SMF. The SMF may configure the UPF in step 10a to report additional information about the UE's user plane traffic and the SMF may send this data to the NWDAF, which then process the data to generate the analytics for the UE's user plane traffic. In step 10c, the SMF subscribes to the NWDAF to receive analytics for the UE using either the Nnwdaf AnalyticSubscription_Subscribe or Nnwdaf_Analyticslnfo_Request service operation. In the request, the SMF may indicate that it will provide the data from the UPF to the NWDAF in future communications. Alternatively, the SMF may let the NWDAF collect data from the UPF using the Nsmf_EventExposure service of the SMF.

Steps 11-14: These steps are performed according to the corresponding steps of the PDU session establishment procedure but with the added information sent by the SMF to the UE to indicate the result of the analytic requests from steps 10a to 10d. The SMF may indicate to the UE in the response that the UE should provide data for analytics, certain types of data for analytics, or certain classes of data for analytics. The SMF may also include information on what type of transport (e.g., NAS, RRC, MDT, or IP) to use to send the data and when or how often to send the data.

FIG. 4 shows how a UE can request the CN to establish data collection and analytics generation for the UE to optimize UP communications when establishing a PDU session. For a more holistic solution, the UE may include an indication specifying the desire to have data analytics performed for UP optimizations as part of a registration request to enable all PDU sessions established for that registration to take advantage of data collection and analytics for optimizing UP communications. The inclusion of the indication to the registration procedure could initiate the generation of URSP rules sent to the UE. The URSP rules may specify that all PDU sessions include the indication specifying the requirement for data collection and analytics from the NWDAF to optimize UP communications when establishing PDU sessions. Similarly, the indication may be included in a service request to activate UP resources that can benefit from data analytics.

In a similar fashion, MA PDU sessions may be enhanced by including the data analytics indication and other indications specified for the PDU session establishment. Both legs of the MA PDU session would be able to take advantage of the requested analytics. In addition, the data analytics may be utilized to make steering decisions between two or more network accesses. A more advanced feature may be enabled that uses the data analytics to dynamically adjust the splitting percentages of traffic between both legs of the MA PDU session. This feature may be combined with autonomous or analytics driven steering modes to provide dynamic capabilities within the user plane to provide the best experience for the user.

### UE Initiated Data Analytics—PDU Session Modification

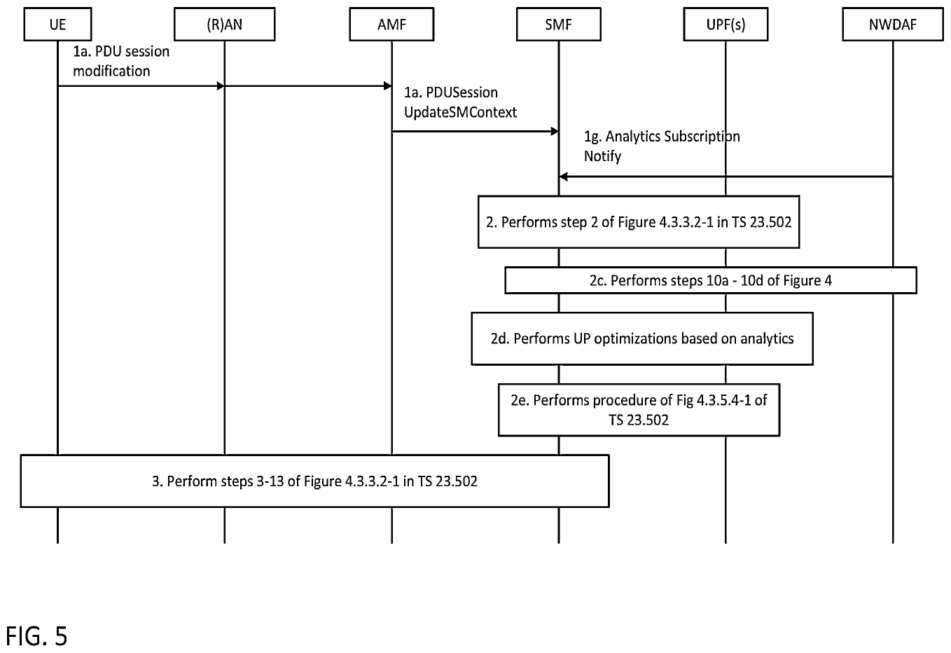

FIG. 4 describes the scenario where the UE is aware of the need for UP optimizations prior to establishing a PDU session based on the activity of a user, e.g., an AR or VR session that requires low latency through local edge servers. In other scenarios, the UE may not have requested using analytics for UP optimization during the initial PDU session establishment and are now experiencing degradation to the UP traffic. FIG. 5 shows enhancements to the PDU Session Modification procedure in which the UE indicates the desire to have data collection and analytics performed to optimize UP communications. This procedure may be initiated when new application traffic is initiated or when traffic triggers the application of a URSP rule that includes indication(s) that data analytics can, or should, be applied to the traffic. The UE may also include the same indications and other information that was previously included in the PDU session establishment procedure in the modification request. FIG. 5 also shows the case in which data analytics was already requested as described by FIG. 4 and the NWDAF is providing analytics to optimize the UP communications. In this case, the NWDAF has sent an Nnwdaf AnalyticsSubscription_Notify service operation to the SMF with the results of the requested analytics.

Step 1a of FIG. 5: In this step, the UE may be experiencing UP degradation at some time after establishing a PDU session. The UE may notice there are more dropped packets that require retransmissions, or the downlink bit rate has decreased significantly from the previous bit rates obtained earlier in the PDU session. As a result, the UE may send a PDU Session Modification request to inform the CN to enable network data collection and analytics be performed to improve UP communications. Similar to the PDU Session Establishment procedure previously described where the UE includes an indication or multiple indications for requesting network data collection and analytics, the UE likewise may include the same indication(s) and other information in the modification request. The UE may also provide a time period for which the UE experienced degradation, a list of locations where the degradation occurs, and a list of Analytics IDs the UE wishes to enable analytics for.

Step 1g: Separately, the PDU Session Modification request may be initiated indirectly by the NWDAF if analytics were previously requested as described by FIG. 4. The NWDAF sends an Nnwdaf_AnalyticsSubscription_Notify service operation to the SMF with the requested analytics output indicating user plane congestion is increasing in the UPF. The NWDAF may elect to initiate, or request, the PDU Session Modification based on receiving a notification from the SMF, or UPF, that a particular type of traffic has been detected. The notification of a particular type of traffic to or from a particular UE may be sent from the NWDAF because the NWDAF previously subscribed to such a notification. Alternatively, the SMF may initiate the PDU Session Modification procedure in response to the notification from the NWDAF. The SMF may use the analytics received from the NWDAF and the information that was provided by the UE when requesting network data collection and analytics to modify the PDU session and make the appropriate UP optimizations, e.g., adjusting the QoS, allocating more resources for the PDU session, or perform UPF reselection.

Step 2: The SMF performs step 2 as outlined in the PDU Session Modification procedure of TS 23.502. If this procedure was triggered by the NWDAF via step 1g, the SMF may update policies based on the analytics provided by the NWDAF to exclude selecting the UPF for new PDU session establishment requests until future analytics result indicates congestion is in decline. The SMF may save information the UE provided in the request in step 1a for future use and for making UP optimizations in response to receiving data analytics from the NWDAF.

Step 2c: If this procedure was triggered by the UE via step 1a, the SMF performs one of the procedures from steps 10a-10d of FIG. 4. This step establishes data collection and analytics to be performed by the NWDAF to optimize UP communications.

Step 2d: The SMF may send the UPF new or modified N4 rules to optimize UP communications based on the results of the analytics received from the NWDAF in step 1g. Alternatively, the SMF may select a new UPF to better serve the UE and move the PDU session to the new UPF.

Step 2e: The SMF may decide to insert an UL-CL or a BP UPF based on the analytics provided by the NWDAF in step 1g. The UL-CL or BP UPF may be required to address cases of UE mobility where the UE has moved from an initial location and needs to be served by another UPF to receive low latency traffic while using the original UPF as an anchor for the traffic.

Steps 3-13: The remaining steps are performed according to steps 3 to 13 of the PDU Session Modification procedure outlined by FIG. 4.3.3.2-1 of TS 23.502. The SMF may include in the response to the UE information on what type of data to collect and what type of transport (e.g., NAS, RRC, MDT, or IP) to use to send the data. The information may include when or how often to send the data.

Similar to the PDU Session Modification procedure, the MA PDU Session Modification procedure may also be enhanced to enable generating analytics for selecting dynamic steering modes over one or both access legs. This procedure may be triggered by the user of a UE or by policies within the UE based on performance measurements obtained for the MA PDU session. The UE may originally be configured to use one of the static steering modes defined in Release 16 but now wants to upgrade to a more dynamic steering mode in which the splitting percentages are adjusted based on the analytics generated by the NWDAF.

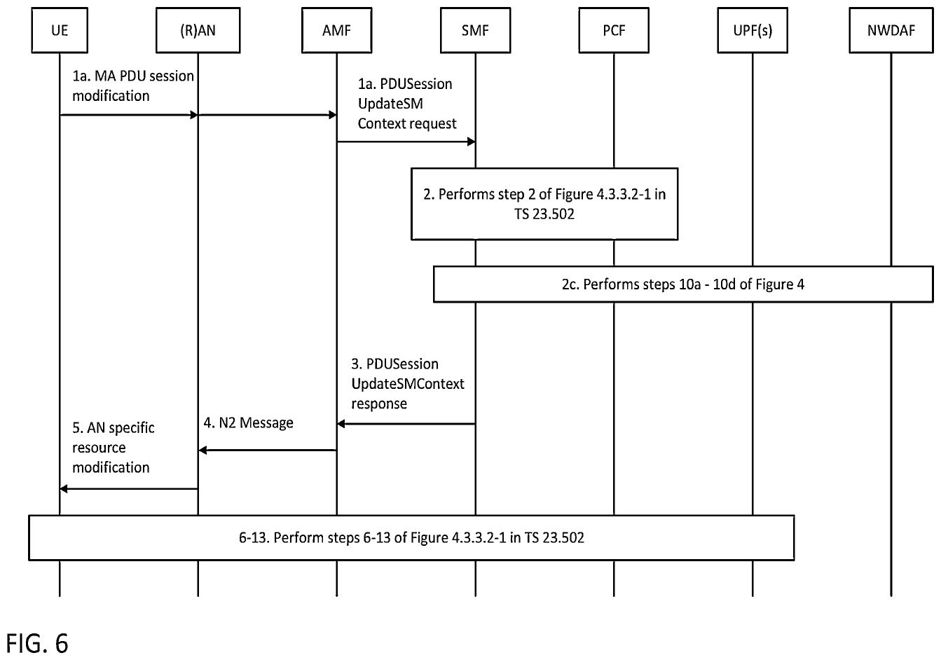

Step 1a of FIG. 6: A UE wishes to take advantage of an analytics driven optimization in the user plane and includes an indication or multiple indications requesting that the network use data analytics in the MA PDU Session Modification request. The UE may be using a static steering mode that does not allow for dynamic splitting between the two access legs of the MA PDU session and may want the steering mode to be updated to allow for more dynamic steering. The UE may include indications and other information as previously proposed for the PDU Session Establishment procedure.

Step 2: The SMF performs step 2 as outlined in the PDU Session Modification procedure of TS 23.502. The SMF may update policies in the PCF based on information received from the UE, which may require generating new ATSSS and N4 rules to modify the MA PDU session. For example, the UE may currently be using a static steering mode and based on the inclusion of an indication requesting data analytics, the SMF may request from the PCF PCC rules to generate ATSSS and N4 rules that utilizes autonomous or analytics driven steering modes. Furthermore, the SMF may perform in step 2c one of the procedures from steps 10a-10d of FIG. 4 to establish data collection and analytics for controlling the splitting percentages of the new steering modes.

Step 3: The SMF returns a response to the PDUSession_UpdateSMContext request and includes new ATSSS rules that takes advantage of UP optimizations provided by the data analytics. The SMF may also include in the response information on what type of data to collect and what type of transport (e.g., NAS, RRC, MDT, or IP) to use to send the data. The information may include when or how often to send the data.

Step 4: The AMF forwards the N1 container to the UE.

Step 5: The (R)AN node forwards the N1 container to the UE.

Steps 6-13: The remaining steps are performed according to steps 6 to 13 of the PDU Session Modification procedure outlined by FIG. 4.3.3.2-1 of TS 23.502.

NWDAF Data Collection from UPF

Once the SMF has made subscriptions to the NWDAF to generate analytics for the UE, the process of data collection begins. Currently in 3GPP specifications, the UPF does not have a service base or reference point interface with the NWDAF and thus, the NWDAF is not able to perform data collection from the UPF. A method for allowing the NWDAF to collect data from the UPF is possible by enhancing existing interfaces: between NWDAF and SMF using the corresponding service interface and between SMF and UPF using the N4 interface. These enhancements will enable the NWDAF to collect data from the UPF and generate analytics to optimize UP communications.

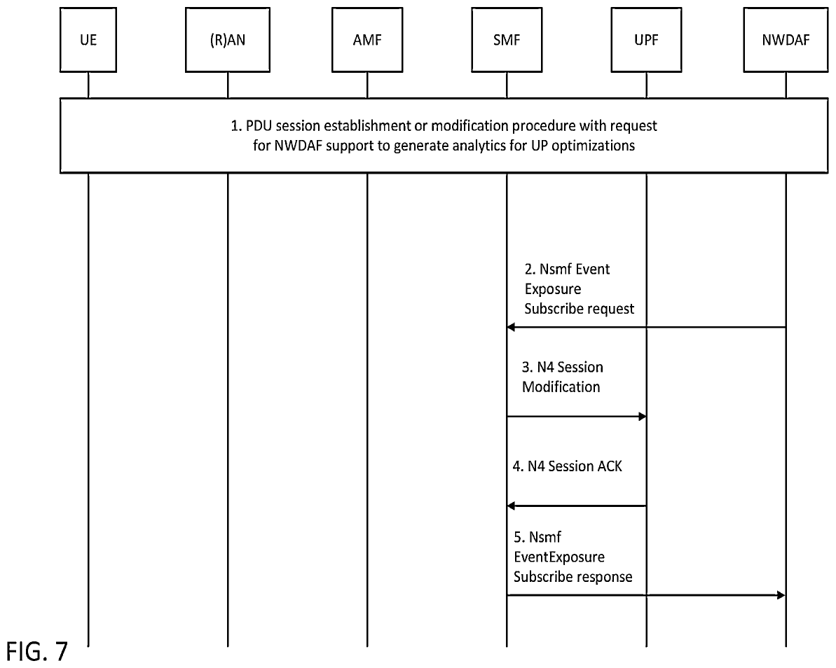

When the SMF subscribes to receive analytics on behalf of the UE from the NWDAF, the SMF may include an indication informing the NWDAF to collect data from the UPF by using the SMF's service based interface. The SMF may even indicate the types of data or the class of data to collect for the analytics. Alternatively, the system may be defined to indicate all data collection required from the UPF are collected through the SMF using the Nsmf_EventExposure_Subscribe service operation. FIG. 7 shows an example procedure where the NWDAF subscribes to collect data from the UPF by using the Nsmf_EventExposure_Subscribe service operation.

Step 1 of FIG. 7: A UE establishes or modifies a PDU or MA PDU session and indicates in the request for NWDAF support of generating analytics for UP optimizations as described by FIG. 4, FIG. 5, or FIG. 6. The SMF has already subscribed to receive analytics on behalf of the UE and has informed the NWDAF to use the Nsmf_EventExposure_Subscribe service operation to collect data from the UPF.

Step 2: The NWDAF uses the Nsmf_EventExposure_Subscribe service operation to subscribe to collect data from the UPF for UP traffic relating to the UE.

Step 3: If the SMF had not already configured the UPF to send to the SMF UP traffic information about the UE, SMF sends the UPF an N4 Session Modification message. The message may include what data to send to the SMF, the UE identifier, the time period to collect the data, etc.

Step 4: The UPF responds with an N4 Session ACK to indicate the UPF is able to collect the required data and within the indicated time duration.

Step 5: The SMF responds to the NWDAF that the subscription for data collection is granted and the SMF will notify the NWDAF when data is available.

The example procedure shown in FIG. 7 may be triggered by the SMF for the UE as previously described. However, such a procedure may also be extended to occasions when the NWDAF needs to collect data from a UPF. This may be triggered by an OAM entity, by other NFs in the system, by network policies in the system, or by configuration in the NWDAF. The data the SMF collects may come from the UE, the UPF, or information the SMF had stored during the PDU session establishment or modification procedures. The information stored in the SMF had originally been provided by the UE as previously described.

### Anonymization of UE Data Collected for Analytics

One concern with providing UE data to the NWDAF for analytics is with UE privacy since a UE identifier is provided to the NWDAF in order for the NWDAF to collect data about the UE. A method in which UE privacy is preserved while enabling the NWDAF the ability to collect data about the UE can be achieved by enhancing the procedure introduced in FIG. 7. In this method, the NWDAF collects data about the UE from the UPF through the SMF. The SMF in turn will communicate with the NWDAF using a token identifier that is associated with the UE and the mapping between the token and UE subscription identifier might only be known by the SMF. The token may be formatted such that it includes the SMF ID so that the token is unique across SMF's. The mapping between the UE identifier and the token identifier may be recorded in charging data records and in the UDM/UDR. The SMF will store in the UE context maintained for this PDU session both the UE identifier and the token identifier. The token identifier will be used in both the data collection and the analytics subscription requests between the SMF and the NWDAF.

FIG. 4 describes two methods with which data from the UPF may be collected by the NWDAF: one, using a new service based interface between the UPF and NWDAF, and two, using existing interfaces between the UPF and SMF and between SMF and NWDAF. The enhancement to the latter method is for the SMF to use a token identifier for the UE instead of a UE identifier when communicating with the NWDAF. The SMF would configure the UPF using an N4 Session Establishment or Modification request as the SMF currently does. However, when the SMF subscribes to the NWDAF to receive analytics for the UE, the SMF includes the token identifier instead of the UE identifier. Furthermore, the SMF will configure the NWDAF to collect data about the UE using this token identifier. Since the SMF is also providing data about the UE, it can substitute the token identifier for the UE identifier when collecting data from the UPF for the NWDAF. The enhancement to the N4 interface between the SMF and the UPF includes any new data reporting required from the UPF in order to collect data for the NWDAF to perform analytics on. The SMF maintains the mapping of the token identifier to the UE identifier within the PDU session context that is stored in the SMF.

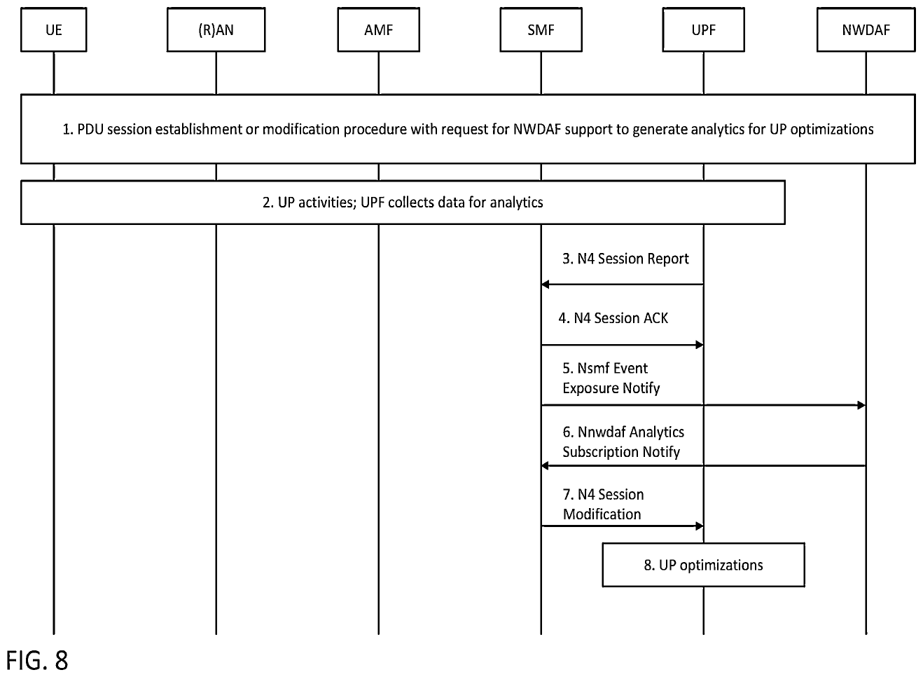

The anonymization of the UE data for analytics may be triggered by the UE with the inclusion of an indication that the UE would like to have anonymized data collection and analytics. This indication may be included with the analytics indication sent in a PDU session establishment or modification message to the CN. The SMF after receiving these indications may perform the anonymized data collection illustrated in FIG. 8. While the inclusion of the analytics indication and one or more Analytics IDs may be an indication that the UE grants permission for the NWDAF to perform data collection and analytics about the UE, the inclusion of the anonymized analytics indication places strict requirements that any data collection and analytics performed for the UE need to be anonymized. When the SMF that serves a PDU session changes, the token value may be provided to the new SMF or the token value may change (e.g., assigned by the new SMF) and the NWDAF may be informed of the token value change.

Step 1 of FIG. 8: A UE establishes or modifies a PDU or MA PDU session and indicates in the request for NWDAF support of generating analytics for UP optimizations as described by FIG. 4, FIG. 5, or FIG. 6. In addition, the UE requests that the data collected about the UE be anonymized and the SMF may assign a token identifier for the UE. The token identifier may be used in place of the UE identifier for communications with the NWDAF and the UPF. The SMF may store the token identifier in the UDM/UDR for future use by other NFs.

The SMF may also return the token identifier to the UE for cases in which the UE provides data as part of the data collection process for the NWDAF. The UE may associate data it collects for the NWDAF with this token identifier, e.g., as part of MDT reports or NAS signaling messages.

Step 2: After the PDU session has been established or modified, UP traffic flows between the UE and the UPF. During this time, the UE and UPF collects data relating to the UP activities that will be sent to the NWDAF for analytics.

Step 3: The UPF sends an N4 Session Report to the SMF and includes the collected data.

Step 4: The SMF responds with an N4 Session ACK to indicate the collected data has been received.

Step 5: The SMF then prepares and packages the data for anonymization of the UE data for the appropriate Analytics ID and sends an Nsmf_EventExposure_Notify message to the NWDAF. In preparing the data, the SMF substitutes the UE identifier with the token identifier associated with the UE to preserve the privacy of the UE. The SMF had previously provided this token identifier in the Nnwdaf_AnalyticsSubscription_Subscribe request to trigger the NWDAF to generate analytics for the UE.

Step 6: After some time, the NWDAF generates the required analytics for the UE to optimize UP communications. The analytics is based on the data provided by the SMF from step 5.

Step 7: Using the analytics returned by the NWDAF, the SMF sends an N4 Session Modification message to the UPF. The message may include modifications to change the QoS, provide steering ratios or percentages for autonomous or analytics driven steering modes, etc. The SMF may insert UL-CL or BP UPFs in the UP or select another UPF to serve the UE as part of the optimization.

Step 8: The UPF applies the appropriate optimizations for the UE and may start a new data collection period after the optimization(s) take effect.

The example procedure of FIG. 8 shows how the SMF may anonymize the data collected for the NWDAF. An alternative would be for the NWDAF to collect the data directly from the UPF if interfaces between the NWDAF and UPF exist. In that case, the SMF would configure the UPF with the both the UE identifier and the token identifier during PDU session establishment or modification procedures and inform the UPF to use the token identifier when subscribing to receive analytics on behalf of the UE from the NWDAF. If supported, the SMF may configure the UPF with only the token identifier. The UPF may alternatively generate the token identifier and map the identifier to the UE internally. Then the UPF would collect data on UP traffic for the UE and may even obtain data from the UE to send to the NWDAF for analytics. Once all the data are collected, the UPF sends the information with the token identifier associated with the UE to the NWDAF.

Note that it may be the case that multiple network functions and the OAM system provide data associated with a UE to the NWDAF. In such a scenario, the UDM/UDR (or some other centralized NF) could be used to anonymize the UE's identifier. When NF's, or the OAM system, provide data collection for the UE to the NWDAF, they can first request an anonymize token for the UE from a central NF (e.g., a UDM/UDR or centralize NWDAF). This approach will guarantee that all NF's use the same anonymize token for the same UE. Alternatively, all NF's can route their input to the NWDAF through an anonymizer function that replaces the UE identifier with a token value.

### Data Collection Requirement for Analytics

Thus far, the indications provided by the UE focuses on local optimizations of the user plane traffic that benefits only the UE. The UE may also provide a separate indication to inform the CN that the data collected about the UE may be used as part of NWDAF data collection to generate analytics for global optimizations (e.g., network-wide) of the user plane. This indication may signal to the SMF that it is able to include data received from the UPF relating to the UE for NWDAF data collection purposes. This includes when the NWDAF requests to collect UP data about the UE, if the UE is part of a group of UEs whose data the NWDAF wants to collect, if NWDAF data collection involves all UEs, or the NWDAF is collecting UP data from a certain UPF that is serving the UE. The indication may also trigger the SMF to configure the UPF to allow sending data about the UE to the NWDAF if a communication interface exists between the UPF and the NWDAF.

Data analytics to optimize UP communications are only useful if it is applied while the UE is actively using UP resources. A UE can inform the CN when establishing or modifying a PDU session whether the PDU session requires real-time data collection and analytics generation. This may be triggered when a user wants to initiate an online gaming session and desire to have UP communications optimized for that session. A new indication can be introduced for inclusion in the PDU session establishment or modification procedure to enable this feature. An SMF receiving this indication may specify time critical analytics to be performed when creating a subscription with the NWDAF. Furthermore, the SMF may place time constraints for the NWDAF to collect data with a certain degree of freshness to ensure the analytics are performed with timely and relevant data.

The data collection would be performed by the UPF and report to either the SMF or the NWDAF, which depends on the available interface between the UPF and NWDAF. An example of data collection information about the UE is shown in Table 1. Note that the table shows that the user plane data collection may be obtained from the UE, the UPF, or even the SMF. The UE may communicate the data it provides to the UPF by encapsulating the required data in normal UL traffic sent by the UE or alternatively, the UE may use the PMF protocol implemented by the ATSSS feature to send the required data to the UPF separate from normal UL traffic packets. The UE may even use RRC or MDT signaling to provide the data to a RAN node, which may forward that data to the UPF and OAM entities respectively.

TABLE 1
Data Collection for Analytics of UP Optimization

| Parameter Name | Source | Description |
|---|---|---|
| Timestamp | UPF | The timestamp the UPF generated the data collection report |
| Reporting Period | UPF | The reporting period of the data collection |
| UPF ID | UPF | The identifier of the UPF generating the data collection report |
| PDU Session ID | UPF | The PDU session ID the data report is associated with |
| S-NSSAI | UE | The S-NSSAI of the PDU session as reported by the UE |
| Location | UE/UPF | The location of the UE or UPF service the UE; can be a tracking |
| Information | | area or cell ID |
| Application | UPF | The types of applications used in the PDU session; alternatively, |
| Types | | this could be an application ID |
| % Loading | UPF | The percentage loading of the UPF during the data collection |
| | | period |
| DL Data Rate | UE | The DL data rate as observed by the UE |
| DL | UPF | The number of DL retransmissions as reported by the UPF |
| Retransmissions | | |
| DL Latency | UE | The DL latency as observed by the UE |
| UL Data Rate | UPF | The UL data rate as observed by the UPF |
| UL | UE | The number of UL retransmissions as reported by the UE |
| Retransmissions | | |
| UL Latency | UPF | The UL latency as observed by the UPF |
| % Access | UE | The % availability of 3GPP and non-3GPP access as reported by |
| Availability | | the UE |
| PDU Session | SMF | The rate at which PDU sessions are established and released at the |
| Activity | | UPF; this can be used to determine loading metric on a per slice |
| | | basis. |
| Battery Drain | UE | The rate at which the UE's battery is drained during this collection |
| Rate | | period; the rate of drain may be associated with a particular |
| | | application if an ID is provided in the data collection. |
| Battery Drain | UE | For longer term impacts, the battery drain history may be collected |
| History | | from the UE. |

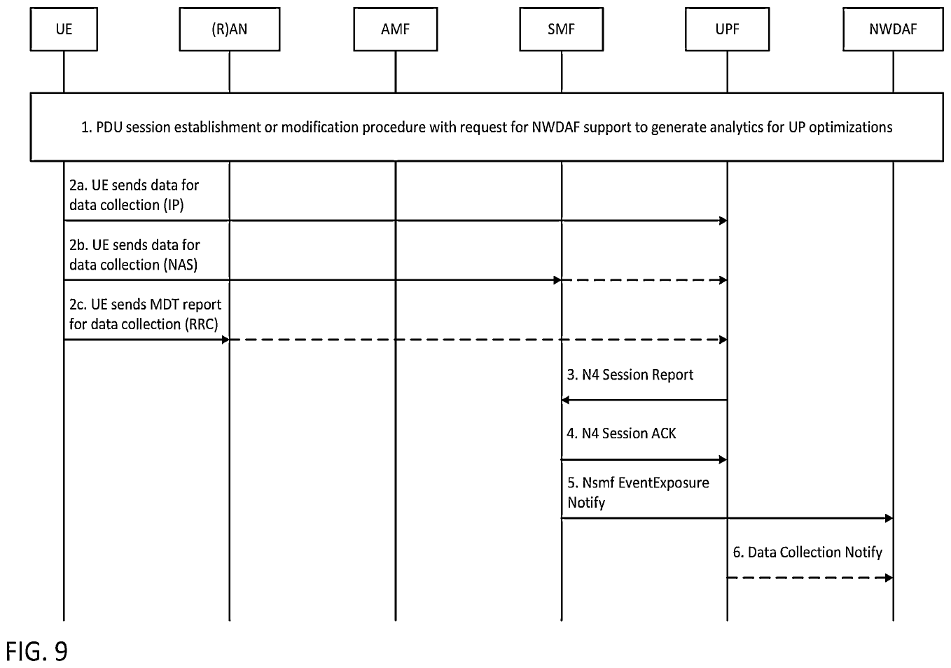

FIG. 9 shows an example procedure where the UE provides data as part of the data collection process required for the NWDAF. The UE may provide this data over IP, NAS, RRC, or MDT signaling to the UPF, SMF, or RAN node. Then either the SMF or the UPF will prepare the data for the NWDAF. If the UE had requested, the data may be anonymized by the SMF or UPF before sending to the NWDAF.

In Step 1 of FIG. 9, a UE establishes or modifies a PDU or MA PDU session and indicates in the request for NWDAF support to generate analytics for UP optimizations as described by FIG. 4, FIG. 5, or FIG. 6. The UE receives in the response information on what type of data to collect and what type of transport (e.g., NAS, RRC, MDT, or IP) to use to send the data. The information may include when or how often to send the data. If the UE needs to send the data using the PMF protocol, the IP address and port of the PMF function in the UPF is provided.

In Step 2, after the PDU session has been established or modified, UP traffic flows between the UE and the UPF. During this time, the UE and UPF collects data relating to the UP activities that will be collected for the NWDAF to perform analytics. If the UE was informed to send data using IP signaling as shown by step 2a, the UE may encapsulate the data with normal data packets sent on UL traffic. Alternatively, the UE may send the data separately using the PMF protocol or some other mechanism if it was informed to do so. If the UE was informed to send data using NAS signaling as shown by step 2b, the UE sends the collected data to the SMF, e.g., using a PDU Session Modification request. The SMF may forward the data to the UPF if the UPF is the final destination for the data, e.g., if the UPF is collecting data for the NWDAF. If the UE was informed to send data using MDT signaling, the UE sends the data in an MDT report to the RAN node and the RAN node may forward the data to the OAM system. The NWDAF later receives the data from the OAM system. The UE may also use RRC signaling to send the data to the RAN node and the RAN node may forward the data to the UPF as shown by step 2c for scenarios where the UE is in RRC IDLE or INACTIVE mode.

Step 3: At the same time, the UPF collects data about the UE and may send an N4 Session Report to the SMF with the collected data. The UPF may include in the N4 Session Report the data received from the UE in step 2a, 2b, or 2c.

Step 4: The SMF responds with an N4 Session ACK to indicate the collected data has been received.

Step 5: The SMF prepares and packages the data and may anonymized the collected data for the appropriate Analytics ID. Then the SMF sends the data to the NWDAF in an Nsmf EventExposure_Notify message. If the data is anonymized, the SMF substitutes the UE identifier with the token identifier associated with the UE to preserve the privacy of the UE. The SMF had previously provided this token identifier in the Nnwdaf AnalyticsSubscription_Subscribe request to trigger the NWDAF to generate analytics for the UE.

Step 6: An alternative to steps 3-5, the UPF may send the collected data to the NWDAF directly. In this case, the SMF may have provided the UPF the UE data received in step 2b that was sent over NAS signaling or the UPF may have received the UE data from the RAN node as shown in step 2c. The UPF may anonymize the data sent to the NWDAF if the SMF had configured the UPF with either a privacy indication or a token identifier to associate with the UE.

### UE Data Collection Through Application Layer

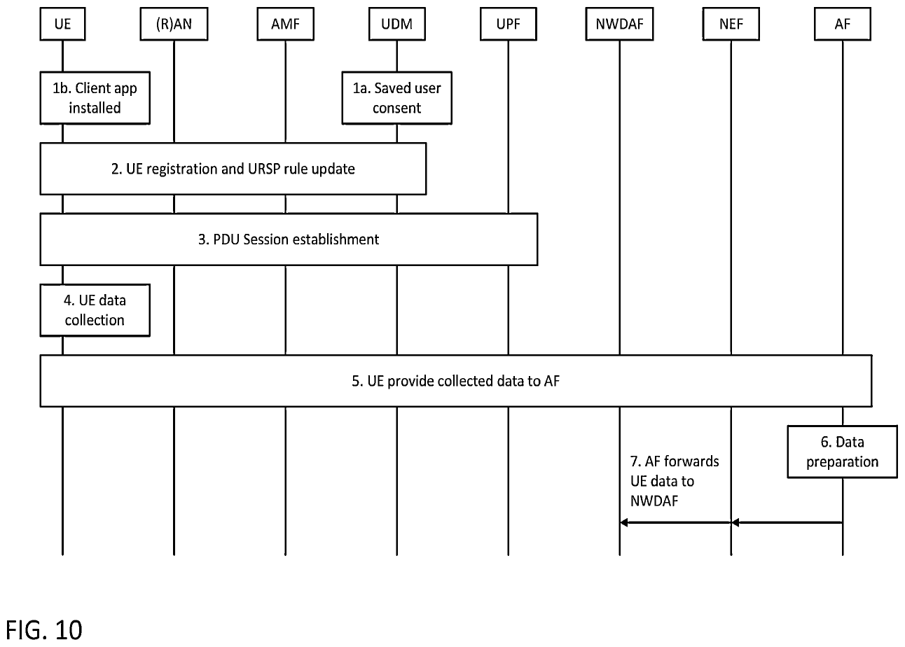

In addition to the methods in which the UE provides data collection reports to the network as shown in FIG. 9, the UE may also provide UE data collection through the application layer via a client application installed on the UE. FIG. 10 shows a procedure in which the mechanisms for UE data collection may be envisioned through the application layer between a client app on the UE and an application server/AF. Note that the terms application server and AF are used inter-changeably hereinafter.

Step 1: As part of this step, user consent is provided and saved in the UDM/UDR in step 1a. Thus far, it has been assumed that user consent was granted to allow for UE data collection. The process of user consent will be described in more detail hereinafter. The user consent may consist of a policy stored in the UDM/UDR that provides the types of data allowed to be collected from the UE, limitations to the sharing of the data to certain NFs, expiration time for the data, required data preparation and/or data transformation, consent for data collection when roaming, etc. Alternatively or additionally, the user consent may consist of one or more Analytics IDs for which consent is granted. Aspects of user consent and information in the policy will be described hereinafter. In addition, a client app is installed on the UE as shown in step 1b. The client app may have been installed as an operator branded app or the app may have been installed during or after obtaining service for the UE. When service is first obtained for the UE, the client app may have been downloaded as part of the onboarding process or as part of a device management operation. Alternatively, the client app may have been installed after obtaining service for the UE via user download as part of an operator's incentive program or promotion. The client app may further be installed as part of a third-party service provider agreement with an operator. The service provider provides the client app for download and install, manages data collection from the UE, and provide either raw or processed data to the operator as part of the agreement. The client app may be pre-provisioned with contact information of the application server or the user may configure the contact information during install and setup, or the client app may be provided with the contact information from the UE. It should also be noted that the UE may host more than one client app. In a scenario where the UE hosts more than one client app, each client app may collect different types of UE data, collect UE data this is associated with different types of applications, collect UE data this is associated with different application instances, or collect UE data this is associated with different network slices. Also, the client app may be an application that not only provides UE data to an AF but the client app may also provide other services to the user (e.g. gaming, etc.).

The app may present the user with options for providing UE data that may be used to enhance the user's experience. UE specific data such as battery levels, battery discharge rate, battery discharge history, battery health, memory usage, sleeping states, location and mobility patterns, experienced data bandwidths, power saving mode (e.g. aggressive, conservative or very conservative, moderate or no power saving), DRX configuration (e.g. DRX cycle) and type of DRX (e.g. regular DRX, extended DRX (eDRX)), level of QoS, QoS profile and configuration parameters for example for all services, a group of services or for a specific service, etc. may be collected and analyzed to guide traffic steering and user plane optimization decisions.

Step 2: Once the client app has been installed on the UE, the UE registers with the network of an operator or performs an update to the UE registration if the client app was installed after the initial UE registration. A UE Data Collection Support Indication may be included in the registration request message signifying the support of data collection by the UE or the fact that the UE may have data collection capabilities. During or after the procedure, the UDM/UDR may trigger the sending of updated URSP rules to the UE to associate the client app with a PDU session targeting a DNN in which the UE data collection application server is located. It should be noted that the URSP rule updates may also be triggered implicitly by the fact that user consent was saved as part of UE subscription data in the UDM/UDR without explicit signaling from the UE. Note the application server may be managed by the operator or by a trusted or untrusted third-party service provider. Similarly, the PCF may trigger a UE Configuration Update procedure for transparent UE Policy delivery to update the UE Policy in the UE, based on the user consent stored in the UDM/UDR. The PCF may have made this determination during the registration procedure based on the indication in the request message signifying the support of UE data collection or alternatively and as a separate procedure, e.g. when the user consent was created or updated in the UDM/UDR. The PCF may have subscribed to changes in the UDM/UDR for the UE and received a notification when the user consent is saved to the UDM/UDR. In the UE Configuration Update, the PCF may provide the UE with new URSP rules associated with the client app. When the UE indicates in the registration procedure that it supports UE data collection, or if user consent was saved as part of UE subscription data in the UDM/UDR, the network may include UE Data Collection Information in the Registration Response. UE Data Collection information may include contact information for the Application Server that UE Data (i.e. Analytics) should be sent to. The contact information may be an FQDN or an IP Address, a port number, the target URI to send data to the AF, the DNN where the AF is located, etc. UE Data Collection Information may further include data collection parameters indicating what type of data the UE should collect, one or more Analytics IDs, the frequency in which to collect the data, the reporting frequency, an indication to include a correlation identifier to associate the UE with the collected data, etc. The network (AMF, NWDAF, etc.) may determine what type of data the UE should collect based on the user consent information that was received from the UDM/UDR. The network may provide the UE with multiple UE Data Collection Information in the registration response. Each UE Data Collection Information instance may be associated with a particular client app and/or network slice. The network may indicate to the UE what client app or network slice is associated with each UE Data Collection Information instance.

The UE Data Collection Support Indication may further include user consent information that was obtained locally from the user (e.g. via GUI configuration or any of the information that is part of the User Consent Profile that is described hereinafter). The UE may provide this consent information to the network and the network may use this information to determine what information to request that the UE collect.

When the UE Data Collection Support Indication is provided during registration, it is part of NAS-MM signaling and is sent from the UE to the AMF. When UE Data Collection information is provided during registration, it is part of NAS-MM signaling and is sent from the AMF to the UE.

The UE Data Collection Information may further include user consent information that was obtained locally from the user (e.g. via GUI configuration or any of the information that is part of the User Consent Profile that is described hereinafter). The network may provide this consent information to the UE and the UE may use this information to determine what data to collect.

Step 3: The client app is launched, and this may trigger the usage of the URSP rule associated with the client app to a certain DN where the application server is located. The DN in the URSP rule may have been pre-provisioned, user configured, or provided by the operator network as previously described. Alternatively, the PDU session establishment procedure may return an updated URSP rule to associate the client app with the PDU session. Note that the client app may be associated to a certain network slice and if the PDU session was not established within that slice, the PDU session may be rejected by the network. As part of the rejection message, a new URSP rule may be sent to guide the UE for future use. The UE may provide the network with a UE Data Collection Support Indication during PDU Session Establishment (or PDU Session Modification) and the SMF may provide the UE with UE Data Collection information in the PDU Session Establishment (or PDU Session Modification) Response.

When the UE Data Collection Support Indication is provided during PDU Session Establishment or PDU Session Modification, it is part of NAS-SM signaling and is sent from the UE to the SMF. When UE Data Collection information is provided during PDU Session Establishment or PDU Session Modification, it is part of NAS-SM signaling and is sent from the SMF to the UE.

Step 4: The UE Data Collection Information stored in the UE may trigger the data collection process within the UE. The information may be pre-provisioned or provided by the network operator or service provider. The policy may describe what types of data are collected, the frequency of data collection, the frequency of data reporting, a timestamp for each collection, a correlation identifier to associate the data with the UE, etc. Note that it may be the case that PDU Session Establishment or Modification is triggered by the generation of application data, thus step 4 may come before step 3.

Step 5: Triggered according to pre-configuration, for example at the appropriate reporting interval, the UE uses the UE Data Collection Information to send the collected data through the user plane to the application server/AF. The UE obtains the contact information for the AF from the UE Data Collection Information. The UE may include additional information to the application server such as the correlation identifier for the UE (e.g. 5G-GUTI, GPSI, IP address and port, etc.), processing requirements for the data, expiration time and expiration policy for the data, a list of NFs allowed to receive the data, whether the data can be shared when the UE is roaming, validity area(s), or default behavior of UE if no validate area is configured, etc. The processing requirements may include data anonymization and/or aggregation indications, data be transformed with statistical operations, data for incorporation into machine learning data set or training data, data processed according to a custom function, etc. Note the processing requirements for the data may be performed by the UE or the AF. The expiration policy may indicate how collected data is to be treated upon expiration, such as removal from the system, request for extension, user notification, etc. For cases in which data may be used perpetually, e.g. such as when data is anonymized or use as part of machine learning data sets, an expiration time may not be included in the data report or the expiration time may be infinite.

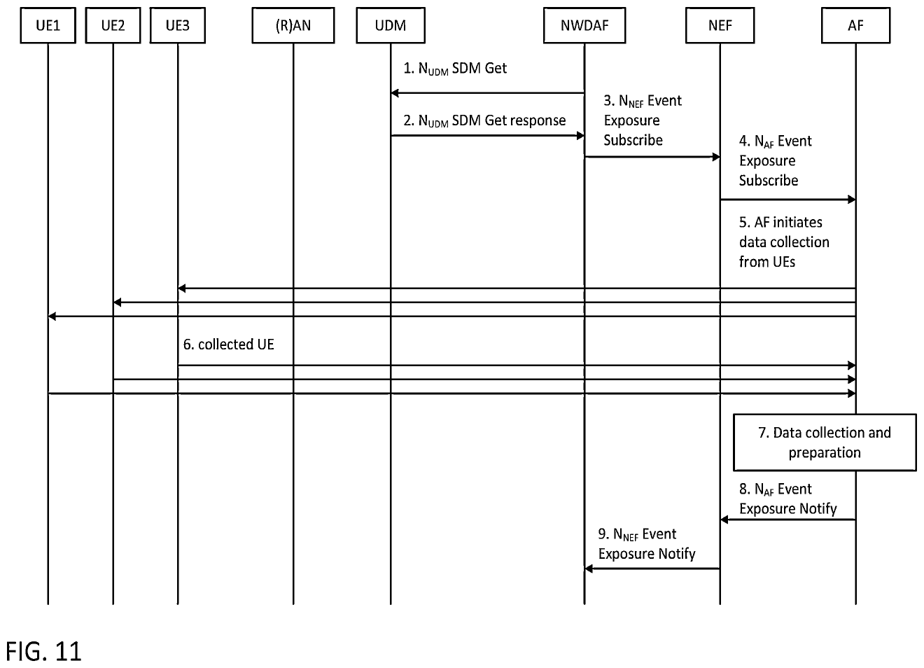

Step 6: Based on the processing requirements sent by the UE, the application server/AF prepares the data accordingly. Alternatively, the UE may have processed the data and include an indication to the AF that the data sent has been processed. The application server may anonymize the data and combine the data with data from other UEs, for example when the application server is collecting data from UEs in a certain location, area, or cell. The application server may also have received requirements from the NWDAF, e.g., when the NWDAF made the data collection request to the AF (e.g. as shown in FIG. 11) on how to generate machine learning data sets and whether to tag the data set as training data. The NWDAF or service provider of the AF may also provide custom or statistical functions the application server uses to transform the data.

Step 7: Then the application server sends the processed and prepared data to the NWDAF through the NEF. The data may be in the format required by the UE or requested by the NWDAF and may include the correlation identifier to associate the data with the UE and other information about the data collection process, e.g. the time stamp of the data collection, the state (e.g. battery level, power saving mode, etc.) and location of the UE during data collection, etc. The NEF may need to use the correlation identifier to associate the data with the UE before sending the data to the NWDAF. Note that if the application server is operator managed, then the application server may send the collected and prepared data directly to the NWDAF and bypass the NEF altogether.

As an alternative to the above procedure, the UDM/UDR may initiate a UE Configuration Update via UDM Control Plane procedure from TS 23.502 after receiving the user consent. The UE Configuration Update message sent to the UE may include the UE Data Collection Information. The message may also include an indication to perform device management operations to download and install the client app or an indication may prompt the user of the UE to accept the download and install of the client app. The UE may be told to re-initiate registration procedure to obtain appropriate URSP rules associated with the client app.

Alternatively, if a central NF is deployed for storing all UE data collected for the NWDAF to generate the network analytics, the AF may send the collected or processed UE data to the central data collecting NF. NWDAF will contact the data collection NF directly to retrieve the desired UE data. In this case, the UE Data Collection Information would contain the contact information, e.g. IP address and port number, of the data collection NF.

### Application Function Data Preparation

The application server/AF may not only collect data from UEs but the application server may also process and prepare the data to be sent to the NWDAF or to other consumer NFs. For example, the NWDAF may request from the application server to collect application traffic of all UEs in a certain geographic area or in certain cells and to aggregate the data or perform some statistical function on the data. The application server may also have the capability to generate machine learning (ML) data sets, whether they are used as training data or as data for ongoing inference. Another aspect of the machine learning support is for the application server to collect UE data that may be used to validate the analytics from the NWDAF. The collected data may be used to calculate the error of an analytics output or the collected data may be used as expected outputs in a training data set. FIG. 11 shows an example procedure in which the NWDAF makes a request to the application server/AF to either collect UE data or to generate machine learning data sets. In the request, the NWDAF may include the requirements for the data collection or data set generation in a Data Preparation policy. The application server uses the information in the Data Preparation policy to prepare the collected UE data. For cases where ML data sets are generated, the collected data may be transformed from raw data into a format where the data set can be used by ML algorithms.

Step 1: An event triggers the NWDAF to start data collection for one or more UEs. This event may be a request from a consumer NF requesting analytics based on data from one or more UE, from a request from OAM, or from some configured system event the NWDAF is generating analytics for and/or an ML or AI data set. The NWDAF performs an NUDM_SDM_Get service operation to first obtain user consent from the one or more UEs from UDM/UDR. The operation may include identifiers for the one or more UEs, a group ID, the types of data to be collected, a list of application IDs that data is collected from, one or more Analytics IDs, the expected time duration of data collection, whether data is anonymized or aggregated, what data transformation functions to process the data with, etc. Alternatively, the NWDAF may perform a Nnrf_NFDiscovery service operation with an NRF to discover an AF that could provide the required data. The NRF may then contact the UDM/UDR to obtain user consent and if granted, the NRF may respond to NWDAF that user consent has been granted.

Step 2: The UDM/UDR checks for the user consent for the one or more UEs. As part of the check, the UDM/UDR may ensure user consent is provided for the types of data requested for data collection, for data from the listed application IDs, for input data specified by the Analytics IDs, whether data anonymization and/or aggregation is allowed, what data transformation functions are required, expiration time, etc. The UDM/UDR returns a response of all the UEs that user consent is allowed for data collection based on the types of data, the application IDs, whether data needs to be anonymized and/or aggregated, an expiration time for the data and the associated expiration options, etc. As an alternative, the UDM/UDR may provide the information to the NRF and the NRF can forward the information to the NWDAF. If user consent is present in the UDM/UDR, the UDM/UDR may contact the AMF(s) that are associated with each UE and initiate a UE Configuration Update procedure with each UE in order to send UE Data Collection Information to each UE as previously described. The content of the UE Data Collection Information may be based on information that was received from the NWDAF.

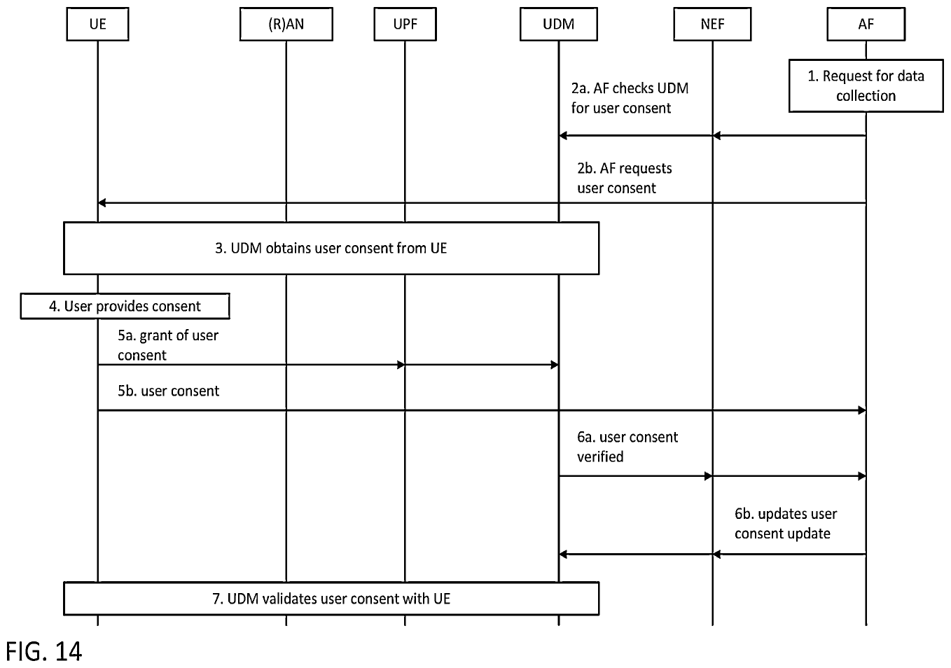

Step 3: The NWDAF, based on pre-configuration or after having discovered an AF that has the capability to collect the desired UE data, sends an EventExposure_Subscribe service operation to the AF via the NEF. The NWDAF may provide the AF information about the user consent, such as the consent for certain data types or from certain applications, whether data is allowed to be modified (e.g. anonymized and/or aggregated), whether data is restricted for use in specific contexts, the expiration of the consent and the expiration options, the validity area(s) of the consent, etc. However, if user consent is not available in the AF, then the NWDAF may trigger the procedure as shown in FIG. 14 in which the AF obtains the user consent either from the UDM/UDR or from the UE. The request may include the types of data to collect, a list of application IDs from which data is to be collected, a list of UEs to collect data from, whether raw or processed data is requested, the targeted location or area of the data collection, etc. If the data to be collected is part of a machine learning or AI data set, the NWDAF may also include a ML or an AI data set profile the AF uses to generate the ML or the AI data set. The ML or AI data set profile may include: a list of UEs whose data is to be collected, the type of data to collect from the UEs, the frequency in which to collect the data, the time validity period for the data collection, the validity area(s), requirement(s) for pre-processing the data, requirement(s) for aggregation or transformation of the data, requirement(s) for limiting the range of the data, units of measurement for the data, the number of data sets required, whether to tag the data set as training data, the NWDAF instance identifier to send the data to, etc.

Step 4: The NEF forwards the message from the NWDAF to the AF with the requirements for data collection and/or data set generation based on the user consent.

Step 5: The AF processes the requirements received from the NWDAF and if necessary, the AF initiates data collection from the UEs. Depending on the requirements provided by the NWDAF, the AF may need to provide the UE with information on what types of data to collect, one or more application IDs whose data should be collected, the frequency of data collection, the reporting frequency, etc. Alternatively, the AF may wait for the UE to contact and authenticate with the AF. The UE may know what AF to contact and authenticate with based on the UE Data Collection Information that may have been received in step 2.

Step 6: The UEs begin data collection activity, making sure the data collection fulfills the requirements specified in the UE Data Collection Information sent by the AF and/or the UDM/UDR. The UE Data Collection Information may also be based on pre-provisioning and/or configuration by a user or service provider. At the appropriate reporting intervals, the UEs send the collected data to the AF.

Step 7: Depending on the requirements provided by the NWDAF, the AF may need to process and prepare the collected data. For example, the data may be anonymized if UEs had included an anonymization indicator with the collected data or if the user consent profile was configured that anonymization was required. In addition, data may be aggregated from multiples UEs or the data may need to be transformed using a specific statistical or custom function provided by the NWDAF or service provider. The data may be normalized or passed through a saturation or clipping function to limit the range of the output. If the data is to be used as part of an ML or AI data set, a tag may need to be included with the data to indicate whether the data set is for training purposes or not. As necessary, the output data may also be formatted as specified by the NWDAF, the user, or service provider.

Step 8: Once all data have been collected and processed, the AF sends an EventExposure_Notify message to the NWDAF via the NEF. The message may include the correlation identifier to associate the data with the UE or the NEF may need to use the correlation identifier to associate the data with the UE before sending the data to the NWDAF.

Note also that other information about the data collection process, e.g. the time stamp of the data collection, the state (e.g. battery level, power saving mode, etc.) and location of the UE during data collection, etc. may also be send. Note that if the AF is operator managed, then the AF may send the collected and prepared data directly to the NWDAF and bypass the NEF altogether.

Step 9: The NEF forwards the message from the AF to the NWDAF with the prepared and formatted data and the correlation identifier. Alternatively, the NEF may include an identifier that the NWDAF can associate the data with the UE.

### User Consent Profile for Data Collection and Enforcement

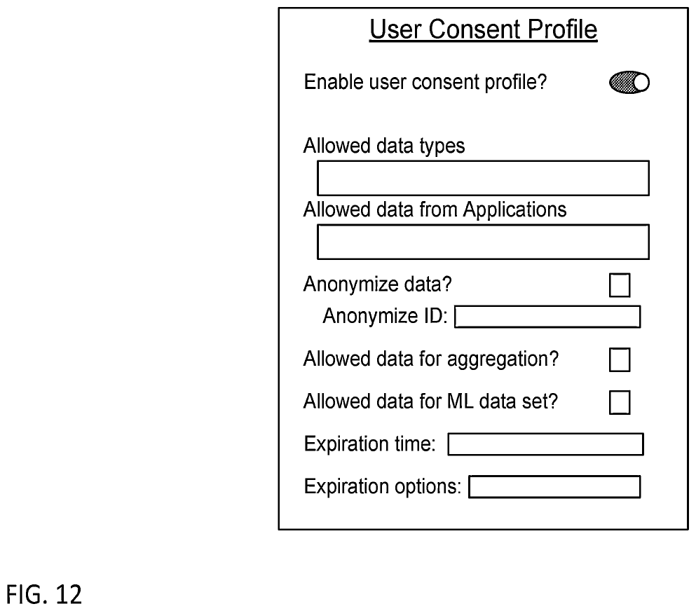

As previously disclosed, user consent is required in order for the network to collect data from the UE. A user consent profile may be maintained to specify the parameters for the user consent and may be comprised of the types of data the user is granting the network to collect, the applications that could provide the data, whether the data requires anonymization with an optional anonymization identifier, whether the data is allowed for aggregation, whether the data can be used in generating machine learning data sets, an expiration time for the data and the associated expiration options, etc. Alternatively additionally, the user consent may consist of one or more Analytics IDs for which consent is granted, e.g., consent is provided for the collection of UE data as specify by the input data of the Analytics ID. FIG. 12 shows an example graphical user interface that may be displayed by a client app to prompt the user to enable user consent for sharing UE data with the NWDAF in the network. The user consent profile may include some of the aforementioned configurations and be enabled or disabled anytime by the user. Alternatively, the user consent profile may be configured by the network upon registration or PDU session establishment procedures or by local configuration of the UE. It should be noted that the information in the user consent profile may be reflected in the UE Data Collection Information where consent is provided to NFs collecting the UE data.

The user consent profile may have parameters that allow a user to specify what types of data to share, e.g. video streaming, internet data, UE specific data such as battery level and memory usage, and/or data from specific applications running on the UE. The expiration time and expiration options parameters are used to indicate the time that user consent is valid and at the expiration time, what to do with the collected data. For example, some expiration options may be to delete the collected data, renew user consent with a renewal identifier, stop data collection but previously collected data may still be used, etc. The expiration options apply to raw data collected from the UE and may not apply to data used for aggregation or data used to generate machine learning data sets. There is also a parameter to request the collected data be anonymized and an option to specify the anonymized identifier to associate the anonymized data. The user consent profile may be enabled or disabled, and when disabled, it signifies that user consent is revoked. One or more user consent profile may exist to manage different types of data or data from different applications.

In addition to what is shown in FIG. 12, the following eleven categories may exemplify the types of data user consent may be enabled for and other categories may also be envisioned.

First is consent for all or no data collection from the UE. Second is consent for data collection associated with input data of one or more Analytics IDs.

Third is consent for data collection that is or is not associated with a specific user profile. This includes UE or application-level user or user profiles.

Fourth is consent for data collection in only specific conditions, e.g. at specific locations, during specific time of days, during driving mode only, etc. Fifth is consent for data collection of only data associated with sponsored data flows. Sixth is consent for data collection within MNO and external to MNO. Seventh is consent for data collection of only data that can be anonymized with specific requirements. Eighth is consent for data collection of only background data. Ninth is consent for data collection to use or not use data beyond the party collecting data. Tenth is consent for data collection associated with certain groups of data categories (e.g. video streaming or data associated with a particular subscription) or protocols (e.g. TCP, UDP, QUIC, etc.). These data may be grouped together within a certain PDU session or access connections (e.g. cellular or Wi-Fi).

Eleventh is consent for data collection associated with error conditions in the UE and/or application specific. The UE may prompt the user during these occurrences to obtain dynamic user consent so data from unexpected events are captured and sent to the network. Alternatively, there may be a configuration for consent that allows for such data collection preemptively.

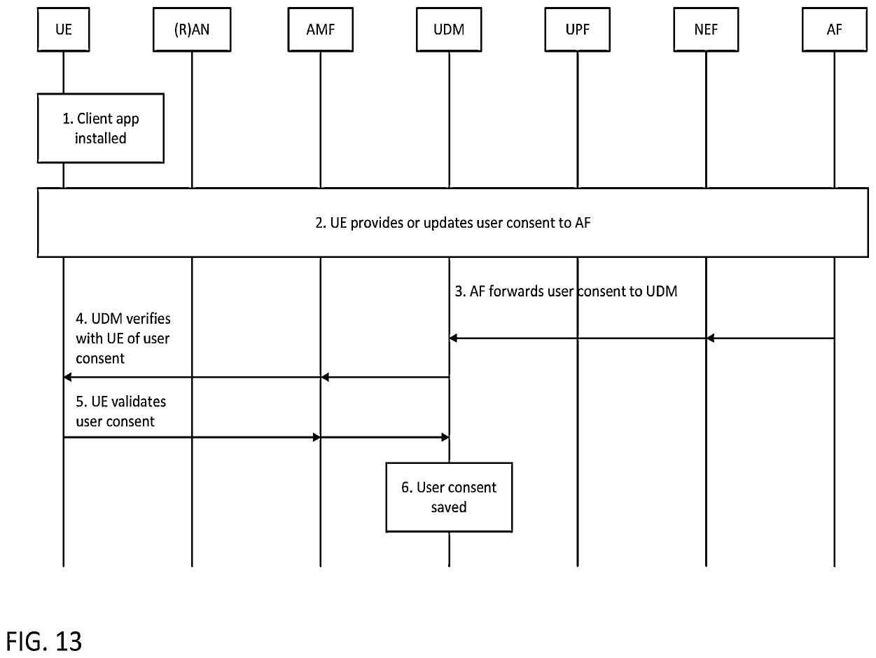

After the user has granted consent for sharing data collected by the UE, the user consent profile or a subset of information in the user consent profile and optionally a correlation identifier may be sent to the application server/AF via the client app at the application layer. The correlation identifier may be used by the application server/AF to associate data collection with the UE. In response, the application server/AF forwards the user consent profile to the UDM/UDR via the NEF. In the case the application server is operator managed, the message may be sent directly to the UDM/UDR, bypassing the NEF. Finally, the UDM/UDR validates the user consent profile was sent by the UE either through the correlation identifier provided with the user consent profile or via two-factor authentication if it is enabled in the user subscription. It should be noted that the user consent profile may be configured as part of UE subscription information in the UDM/UDR without explicit signaling from the UE as shown in FIG. 10. FIG. 13 shows the user consent configuration and validation procedure in greater details.

Step 1: The client app is installed on the UE as previously described. Upon launch, the app displays a graphical user interface, e.g. such as the one shown in FIG. 12, prompting the user to configure the user consent profile for providing UE data to the network. The user may then populate the fields found in the user consent profile to enable data collection at the application layer. Alternatively, the fields of the user consent profile may be pre-configured as part of installation or be configured by the network or service provider. As a result, the user may only need to confirm the configurations of the user consent profile. Yet another alternative is that the UE may display or prompt a dialog box with a question followed by a Yes/No option for user to select. Any data access or usage consent may be provided by the user using a GUI in the UE via Yes/No answers. A consent profile may be created based on the user's answers.

Step 2: After the user confirms the user consent profile, the client app sends the profile to the application server/AF. The client app may include an identifier to associate the user consent profile with the UE's subscription as validation that the UE sent the user consent profile to the application server. For the case where the application server is managed by a third-party service provider, the identifier may be encrypted.

Step 3: The application server then forwards the user consent profile with the encrypted identifier to the UDM/UDR via the NEF. The application server may format the user consent profile if required before sending the profile to the UDM/UDR. Note that if the application server/AF is operator managed, the application server can send the user consent profile directly to the UDM/UDR and bypass the NEF. In this case, the identifier may be a UE identifier that the operator network may have assigned to the UE.

Step 4: If the application server is managed by a third-party service provider, the UDM/UDR may optionally send the UE via the AMF, a user consent verification message to ensure the user consent profile was provided by the UE. The verification message may be an SMS message that is sent to the UE by the UDM/UDR via the SMSF or SMS-SC and may be sent if two-factor authentication was enabled in the UE subscription. The verification message may alternatively be an sent to the UE via a UDM/UDR initiated UE Configuration Update procedure.

Step 5: After receiving the verification message, the UE may display a prompt for the user to respond to or alternatively, the UE may display a notification that an SMS message has been received. In response, the user may acknowledge the prompt or SMS message to validate the user consent profile. The UE then sends a response to validate the user consent profile.

Step 6: If an identifier was provided with the user consent profile, the UDM/UDR checks whether the identifier is associated with a UE subscription. The UDM/UDR may need to decrypt the identifier if it was encrypted. The identifier may be a 5G-GUTI, SUPI, GPSI, External Group Identifier, or some other identifier the UDM/UDR maintains as context associated with a UE's subscription. Note that the identifier provided may depend on whether the AF is operator managed or third-party service provider managed.

Once user consent has been granted and saved in the UDM/UDR, any network function that wants to collect data from a UE must check with the UDM/UDR before initiating data collection. The application server/AF may provide this functionality in response to data collection requests from the NWDAF. As an example, the NWDAF may request the application server to collect downlink data rate from a list of UEs. In response, the application server may query the UDM/UDR using the Nudm_SDM_Get or Nudm_ParameterProvision_Get service operation to check on the status of the user consent for each of the UEs and after user consent has been obtained from the UDM/UDR, the application server may start collecting downlink data rate from the UEs. Note that the indicated service operations may require an enhancement to existing functionality to support the user consent inquiry from the application server.

In certain cases, user consent may not be available in an AF when the AF receives a request for data collection from the NWDAF. These cases may manifest for times when a previous user consent has expired or when user consent has never been previously established between the AF and the client app on the UE. The AF may need to first obtain user consent from the UE before data collection can begin. This process may be accomplished between the client app on the UE and the application server/AF or by the AF checking for user consent with the UDM/UDR. FIG. 14 shows an example procedure where an AF does not have user consent from the UE upon receiving a data collection request from the NWDAF. As a result, the AF proceeds to check for user consent from the UDM/UDR. Alternatively, the AF may request the user consent from the UE if user consent had previously been provided by the UE but the user consent has expired. After receiving the user consent from the UE, the AF forwards the consent to the UDM/UDR for storage. The UDM/UDR may optionally validate the user consent with the UE as previously described.

Step 1: An AF receives a request for data collection from NWDAF. The request includes data collection from a UE in which the AF does not have user consent from.

Step 2: The AF checks with the UDM/UDR in step 2a for user consent from the UE and after granting user consent to the AF, the UDM/UDR may contact the AMF that is associated with the UE and initiate a UE Configuration Update procedure with the UE in order to send UE Data Collection Information to the UE as previously described. The AF may not have previously established communications with the UE and does not have context of the client app installed on the UE. Alternatively, and as shown in step 2b, the AF sends a request to obtain user consent from the UE. This may be the case in which the AF had previously established user consent with the UE but the user consent has expired and the AF needs to renew the user consent. The request may contain the types of data that is being requested for data collection, the frequency of data collection, the reporting frequency, and other information as found in the user consent profile or previously disclosed.

Step 3: If the AF had checked with the UDM/UDR for user consent and the UDM/UDR does not have user consent from the UE, then the UDM/UDR may perform the UE Configuration Update via UDM Control Plane procedure as previously described in which the user consent is obtained from the UE. The UE Configuration Update message that is sent to the UE may include a request for user consent and the response from the UE may include any of the information from the User Consent Profile. If the UDM/UDR has user consent information in the UE subscription data, this step may be skipped.

Step 4: After receiving the request for user consent, the UE may prompt the user to grant consent. If the client app has not been installed, the network may prompt the UE to install the app either manually via a prompt or as part of a device management procedures. If the client app has already been installed, an app notification may prompt the user to grant the user consent. A screen showing the user consent profile may appear on the UE for the user to review the contents of the profile before granting consent.

Step 5: After the user grants the consent, the UE sends a message to either the UDM/UDR or the AF depending on whether step 2b or step 3 triggered the request for user consent. In step 5a, the user consent is sent to the UDM/UDR, while the user consent is sent to the AF in step 5b.

Steps 6a and 6b: In step 6a, the UDM/UDR sends the granted user consent to the AF. However, if the user consent was obtained by the AF, the AF sends an update request to the UDM/UDR in step 6b to update a user consent that may have expired.

Step 7: The UDM/UDR optionally validates the user consent with the UE as was previously discussed.

After the user consent policy has been disseminated and applied, the network needs to ensure the policy is enforced until the expiration of the policy or until the user revokes the user consent. The NWDAF may manage the enforcement of the user consent policy by maintaining expiration of the user consent for each UE and with a list of consumers the data has been shared with. The NWDAF may manage the expiration time internally and notify all consumers of the UE data upon expiry of the user consent. The UDM/UDR may alternatively manage the expiration time of the user consent and the NWDAF and other data consumers may subscribe to get notification at the expiry of the user consent. The existing service operations of the UDM/UDR or NWDAF may be enhanced to allow for the enforcement of the user consent. This is a more centralized approach and may make managing the expiration time simpler.

Alternatively, a more distributive approach may be employed. The expiration of the user consent may be maintained with the collected data and each consumer is responsible for managing the data according to the expiration options at the expiration of the user consent. Depending on the expiration options, the consumer may be able to renew the user consent quickly by providing a renewal identifier. The renewal identifier may be sent to either the UDM/UDR or the UE, e.g. between the application server and the client app on the UE, to renew the user consent. Since the application server has already established communications with the client app, it is able to contact the client app directly to renew the user consent. The application server may be configured to provide notifications to the client app as a reminder to renew user consent prior to the expiration of the user consent. This can ensure data collection is not interrupted and/or deleted. The renewal identifier may also be sent to the UE from the UDM/UDR via the UE Configuration Update procedure to renew the user consent.

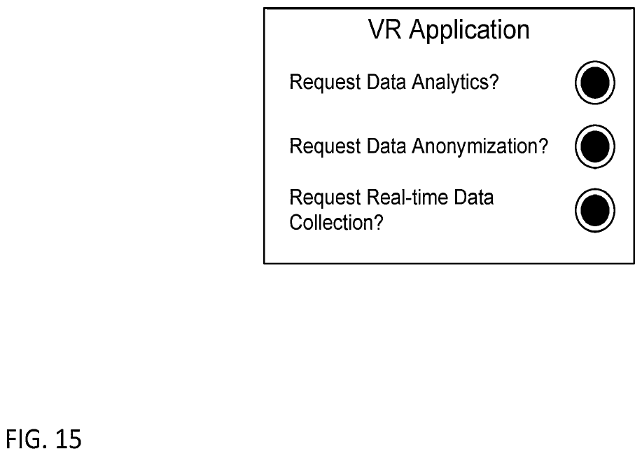

FIG. 15 shows an example GUI presented to the user of a UE after the user launches a VR application. The GUI prompts the user on whether to request data analytics for the PDU session associated with the VR application, whether to request anonymization during data collection, and whether to request real-time data collection for the analytics generation. The GUI may alternatively be found in OAM systems belonging to network operators that are used to configure user preferences using an online portal. Based on the configuration, URSP rules may be generated by the network and sent to the UE to remove the requirement of user involvement.

### Example Environments

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), and LTE-Advanced standards. 3GPP has begun working on the standardization of next generation cellular technology, called New Radio (NR), which is also referred to as “5G”. 3GPP NR standards development is expected to include the definition of next generation radio access technology (new RAT), which is expected to include the provision of new flexible radio access below 6 GHz, and the provision of new ultra-mobile broadband radio access above 6 GHz. The flexible radio access is expected to consist of a new, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 6 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (e.g., broadband access in dense areas, indoor ultra-high broadband access, broadband access in a crowd, 50+ Mbps everywhere, ultra-low cost broadband access, mobile broadband in vehicles), critical communications, massive machine type communications, network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, and virtual reality to name a few. All of these use cases and others are contemplated herein.

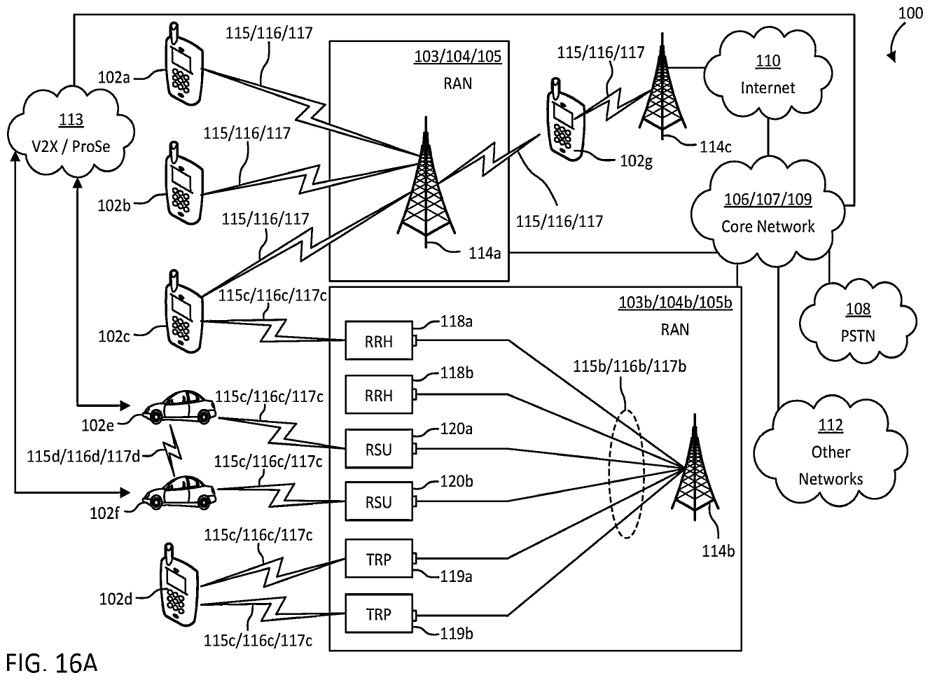

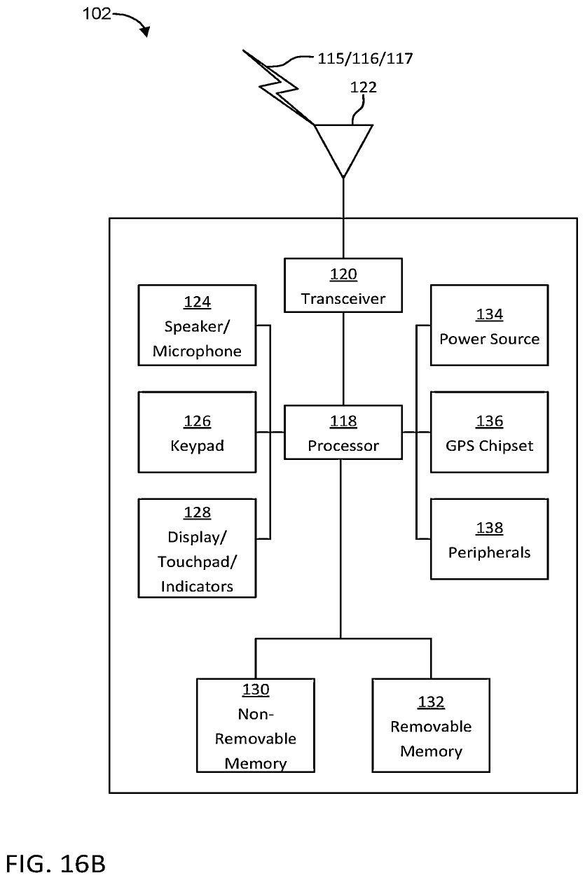

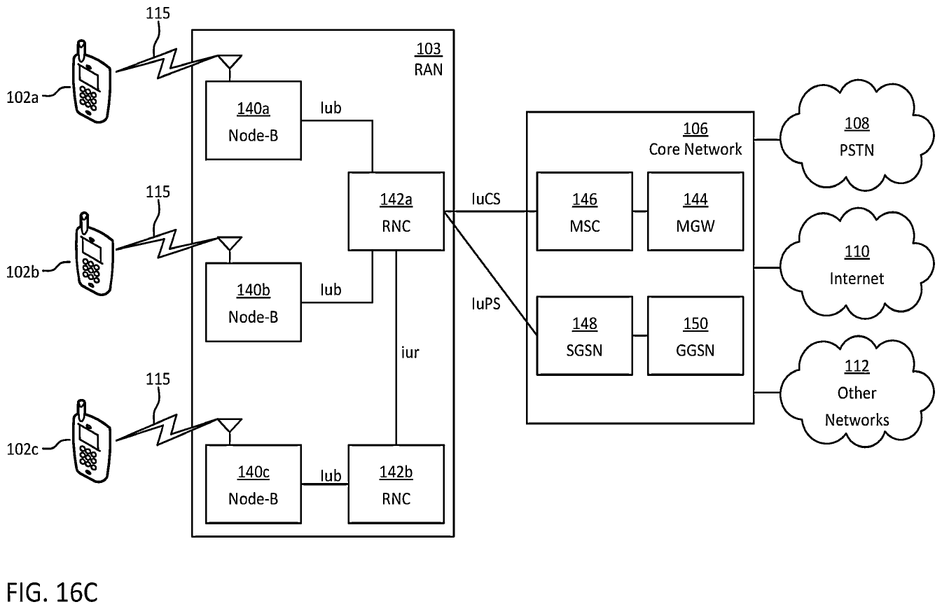

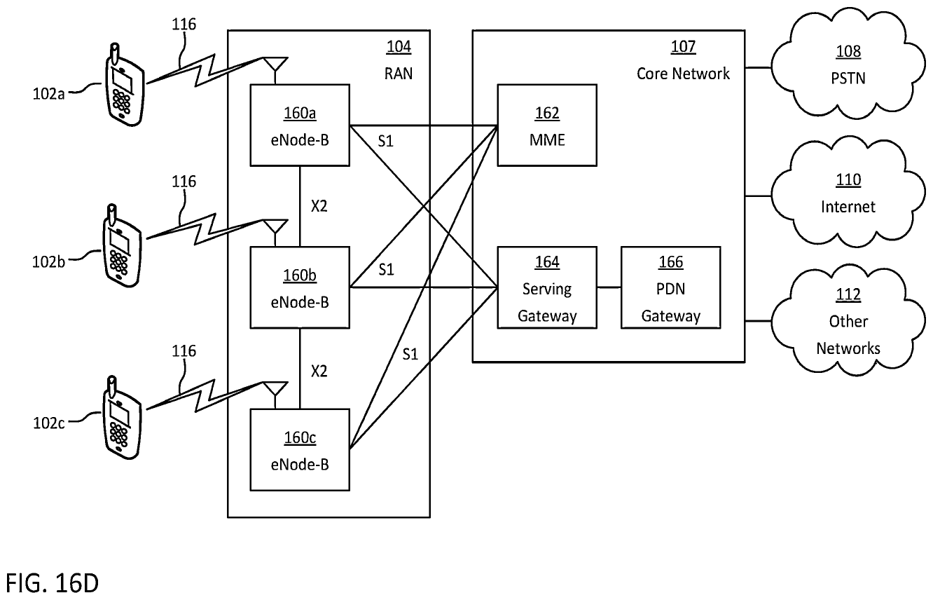

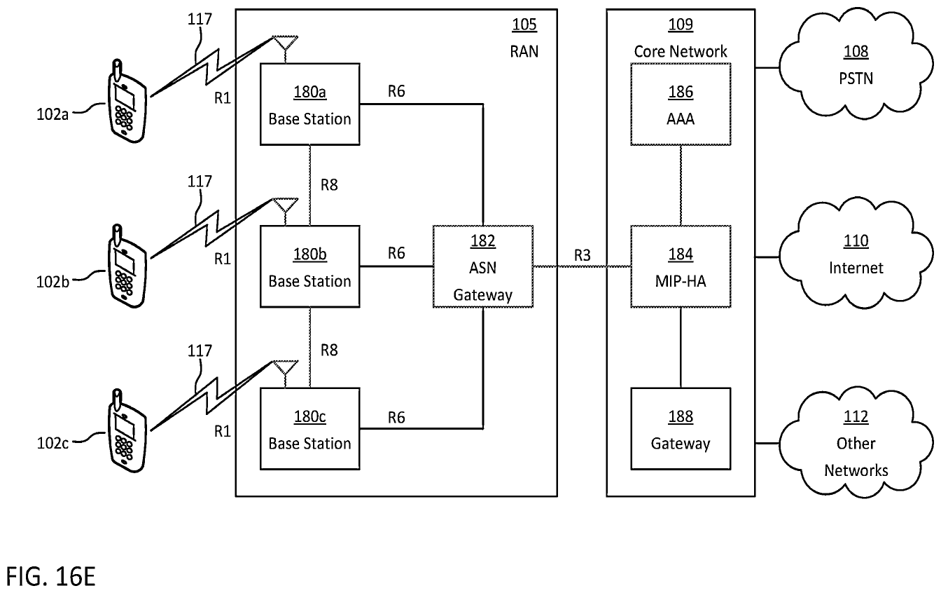

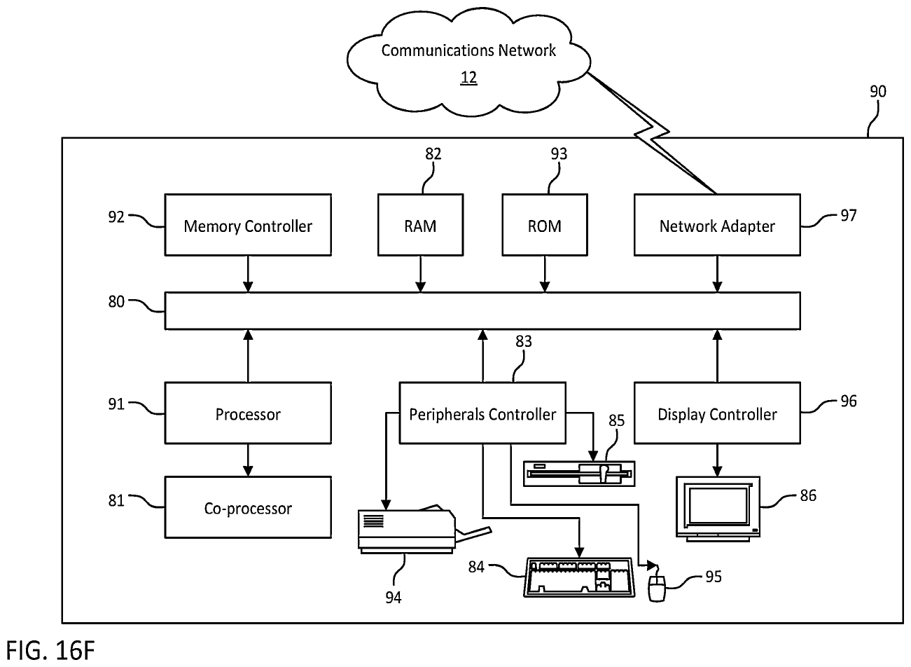

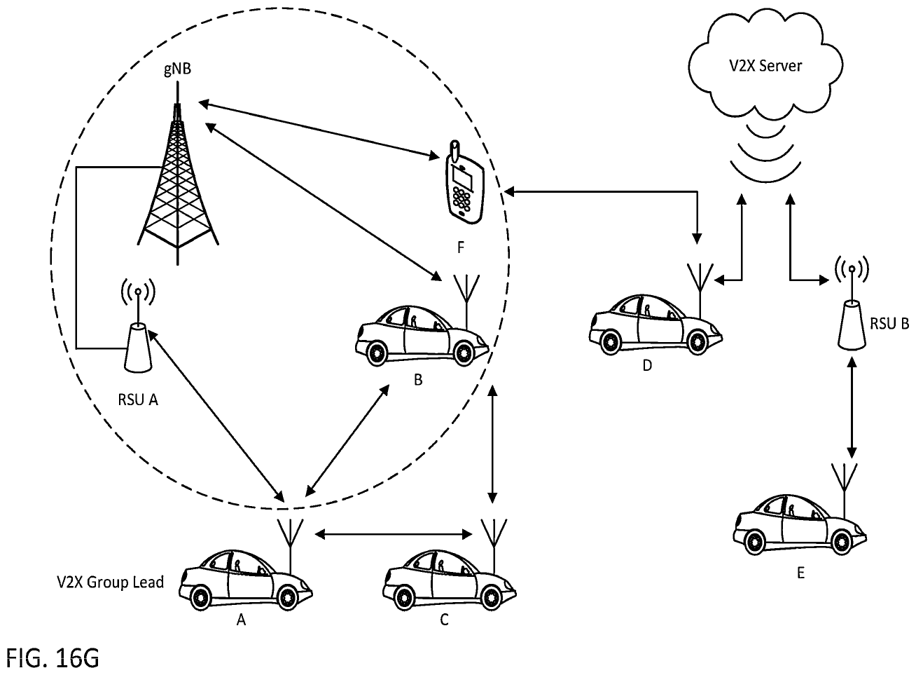

FIG. 16A illustrates one embodiment of an example communications system 100 in which the methods and apparatuses described and claimed herein may be embodied. As shown, the example communications system 100 may include wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/105b, a core network 106/107/109, a public switched telephone network (PSTN) 108, the Internet 110, other networks 112, and V2X server (or ProSe function and server) 113, though it will be appreciated that the disclosed embodiments contemplate any number of WTRUs, base stations, networks, and/or network elements. Each of the WTRUs 102a, 102b, 102c, 102d, 102e, 102f, 102g may be any type of apparatus or device configured to operate and/or communicate in a wireless environment. Although each WTRU 102a, 102b, 102c, 102d, 102e, 102f, 102g is depicted in FIGS. 16A-16E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, in an embodiment, the base station 114a may include three transceivers, e.g., one for each sector of the cell. In an embodiment, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c,102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b,TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c, or RRHs 118a, 118b, TRPs 119a, 119b, and/or RSUs 120a, 120b, in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications, etc.) The 3GPP NR technology includes NR V2X technologies and interface (such as Sidelink communications, etc.)

In an embodiment, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 16A may be a wireless router, Home Node B, Home eNode B, or access point, for example, and may utilize any suitable RAT for facilitating wireless connectivity in a localized area, such as a place of business, a home, a vehicle, a campus, and the like. In an embodiment, the base station 114c and the WTRUs 102e, may implement a radio technology such as IEEE 802.11 to establish a wireless local area network (WLAN). In an embodiment, the base station 114c and the WTRUs 102d, may implement a radio technology such as IEEE 802.15 to establish a wireless personal area network (WPAN). In yet another embodiment, the base station 114c and the WTRUs 102e, may utilize a cellular-based RAT (e.g., WCDMA, CDMA2000, GSM, LTE, LTE-A, etc.) to establish a picocell or femtocell. As shown in FIG. 16A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication.

Although not shown in FIG. 16A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/105b or a different RAT.

Some or all of the WTRUs 102a, 102b, 102c, 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 16A may be configured to communicate with the base station 114a, which may employ a cellular-based radio technology, and with the base station 114c, which may employ an IEEE 802 radio technology.

FIG. 16B is a block diagram of an example apparatus or device configured for wireless communications in accordance with the embodiments illustrated herein, such as for example, a WTRU 102. As shown in FIG. 16B, the example WTRU 102 may include a processor 118, a transceiver 120, a transmit/receive element 122, a speaker/microphone 124, a keypad 126, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 16B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 16B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 16B as a single element, the WTRU 102 may include any number of transmit/receive elements 122. More specifically, the WTRU 102 may employ MIMO technology. Thus, in an embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 16C is a system diagram of the RAN 103 and the core network 106 according to an embodiment. As noted above, the RAN 103 may employ a UTRA radio technology to communicate with the WTRUs 102a, 102b, and 102c over the air interface 115. The RAN 103 may also be in communication with the core network 106. As shown in FIG. 16C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 16C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 16C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 16D is a system diagram of the RAN 104 and the core network 107 according to an embodiment. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 16D, the eNode-Bs 160a, 160b, 160c may communicate with one another over an X2 interface.

The core network 107 shown in FIG. 16D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 16E is a system diagram of the RAN 105 and the core network 109 according to an embodiment. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 16E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell in the RAN 105 and may include one or more transceivers for communicating with the WTRUs 102a, 102b, 102c over the air interface 117. In an embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 16E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 16E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 16A, 16C, 16D, and 16E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 16A-16E are provided by way of example only, and it is understood that the subject matter disclosed and claimed herein may be embodied or implemented in any similar communication system, whether presently defined or defined in the future.

FIG. 16F is a block diagram of an exemplary computing system 90 in which one or more apparatuses of the communications networks illustrated in FIGS. 16A, 16C, 16D, and 16E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109, PSTN 108, Internet 110, or Other Networks 112 of FIGS. 16A-16E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 16G illustrates one embodiment of an example communications system 111 in which the methods and apparatuses described and claimed herein may be embodied. As shown, the example communications system 111 may include wireless transmit/receive units (WTRUs) A, B, C, D, E, F, a base station, a V2X server, and a RSUs A and B, though it will be appreciated that the disclosed embodiments contemplate any number of WTRUs, base stations, networks, and/or network elements. One or several or all WTRUs A, B, C, D, E can be out of range of the network. In the example of FIG. 16G, the cell coverage boundary shown as a dashed line. WTRUs A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable, and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

1-20. (canceled)

21. A user equipment (UE) comprising a processor, communications circuitry connected to a wireless network, and a memory comprising instructions, wherein:
the instructions comprise a client application involved in data collection;
the client application is configured with contact information pertaining to an Application Function (AF);
the client application is configured with data collection information comprising data collection parameters; and
the instructions, when executed by the processor and in accordance with the data collection parameters, cause the UE to:
collect data pertaining to the UE; and
send, to the AF over a user plane, the collected data with information selected from the data collection information.

22. The UE of claim 21, wherein the data collection parameters comprise: a type of data the UE is to collect, data associated with one or more analytics IDs and application IDs, a data collection frequency, and/or a reporting frequency.

23. The UE of claim 21, wherein the data collection information comprises: a processing requirement, an expiration time for the collected data, a timestamp of the data collection, and/or a correlation identifier that associates the collected data with the UE.

24. The UE of claim 21, wherein the collected data comprises: a battery level, a battery discharge rate, a battery discharge history, a battery health, a Discontinuous Reception (DRX) configuration, a sleeping state, and/or a power saving mode.

25. The UE of claim 24, wherein the collected data comprises:
an application ID;
location information;
Single-Network Slice Selection Assistance Information (S-NSSAI);
a Protocol Data Unit (PDU) session ID;
a Downlink (DL) data rate;
a number of Uplink (UL) retransmissions;
a DL latency;
a percentage of device loading;
a percentage of access availability;
a Quality of Service (QoS) level; and/or
a mobility pattern.

26. The UE of claim 21, wherein the instructions cause the UE, prior to sending the collected data, to prepare the collected data by anonymizing, aggregating, and/or normalizing the collected data.

27. The UE of claim 26, wherein the instructions cause the UE to generate, from the collected data, Machine Learning (ML) or Artificial Intelligence (AI) data for use in data analytics.

28. The UE of claim 27, wherein the ML or AI data comprises training data, inference data, and/or validation data.

29. The UE of claim 21, wherein the instructions cause the UE to be managed by an operator, a trusted third-party service provider, or an untrusted third-party service provider.

30. A non-transitory computer-readable medium storing instructions that, when executed by one or more processors of a user equipment (UE), cause the UE for perform a method comprising:
executing a client application involved in data collection, the client application being configured with contact information pertaining to an Application Function (AF) and with data collection information comprising data collection parameters;
collecting data pertaining to the UE in accordance with the data collection parameters; and
sending, to the AF over a user plane, the collected data with information selected from the data collection information.

31. A method of a user equipment (UE), the method comprising:
executing a client application involved in data collection, the client application being configured with contact information pertaining to an Application Function (AF) and with data collection information comprising data collection parameters;
collecting data pertaining to the UE in accordance with the data collection parameters; and
sending, to the AF over a user plane, the collected data with information selected from the data collection information.

32. The method of claim 31, wherein the data collection parameters comprise: a type of data the UE is to collect, data associated with one or more analytics IDs and application IDs, a data collection frequency, and/or a reporting frequency.

33. The method of claim 31, wherein the data collection information comprises: a processing requirement, an expiration time for the collected data, a timestamp of the data collection, and/or a correlation identifier that associates the collected data with the UE.

34. The method of claim 31, wherein the collected data comprises: a battery level, a battery discharge rate, a battery discharge history, a battery health, a Discontinuous Reception (DRX) configuration, a sleeping state, and/or a power saving mode.

35. The method of claim 34, wherein the collected data comprises:
an application ID;
location information;
Single-Network Slice Selection Assistance Information (S-NSSAI);
a Protocol Data Unit (PDU) session ID;
a Downlink (DL) data rate;
a number of Uplink (UL) retransmissions;
a DL latency;
a percentage of device loading;
a percentage of access availability;
a Quality of Service (QoS) level; and/or
a mobility pattern.

36. The method of claim 31, wherein the UE, prior to sending the collected data, prepares the collected data by anonymizing, aggregating, and/or normalizing the collected data.

37. The method of claim 36, wherein the UE generates, from the collected data, Machine Learning (ML) or Artificial Intelligence (AI) data for use in data analytics.

38. The method of claim 37, wherein the ML or AI data comprises training data, inference data, and/or validation data.

39. The method of claim 31, wherein the UE is managed by an operator, a trusted third-party service provider, or an untrusted third-party service provider.
